(19) United States
(12) Patent Application Publication
(10) Pub. No.: US 2026/0239052 A1
(43) Pub. Date: Aug. 13, 2026

(54) Handling Quality of Experience Measurements

(71) Applicant: Telefonaktiebolaget LM Ericsson (publ), Stockholm (SE)

(72) Inventors: Cecilia Eklöf, Täby (SE); Johan Rune, Lidingö (SE); Luca Lunardi, Genova (IT); Filip Barac, Huddinge (SE); Agne Aberg Larsson, Uppsala (SE); Vengatanathan Krishnamoorthi, Linköping (SE)

(21) Appl. No.: 19/158,317

(22) PCT Filed: Feb. 26, 2024
(86) PCT No.: PCT/SE2024/050178

§ 371 Date: Aug. 20, 2025

Related U.S. Application Data
(60) Provisional application No. 63/448,160, filed on Feb. 24, 2023.
(60) Provisional application No. 63/457,588, filed on Apr. 6, 2023.

(51) Int. Cl. H04W 24/08

(52) U.S. Cl. CPC H04W 24/08

(57) ABSTRACT

The present disclosure provides a method performed by a user equipment (UE) for handling quality of experience (QoE) measurements. The method comprises establishing (402) connectivity to a primary network node of a network and a secondary network node of the network, and triggering (404) a release, at the UE, of configurations for the QoE measurements. The configurations are configured by the secondary network node. The release is triggered in response to a termination of the connectivity to the secondary network node.

### TECHNICAL FIELD

The present disclosure relates to methods of handling quality of experience measurements, and a user equipment and network node configured to perform those methods.

### BACKGROUND

An overview of a Quality of Experience (QoE) framework will first be described.

QoE measurements, also referred to as “application layer measurements”, have been specified for Long Term Evolution (LTE) and Universal Mobile Telecommunications System (UMTS) and are being specified for New Radio (NR) in the Third Generation Partnership Project (3GPP) Release 17. The purpose of the application layer measurements is to measure the end user experience when using certain applications. Currently QoE measurements for streaming services and for MTSI (Mobility Telephony Service for Internet Protocol Multimedia Subsystem (IMS)) services are supported. For NR, it is likely that at least Virtual Reality (VR) is added to the list of services for which QoE measurements are specified and supported.

The solutions in LTE and UMTS are similar with the overall principles as follows. Quality of Experience Measurement Collection (QMC) enables configuration of application layer measurements in the UE and transmission of QoE measurement result files (commonly referred to as QoE reports) to the network by means of Radio Resource Control (RRC) signalling. An application layer measurement configuration (also called QoE measurement configuration or QoE configuration) that the Radio Access Network (RAN) receives from the Operation and Maintenance (OAM or O&M) system, or the Core Network (CN) is encapsulated in a transparent container, which is forwarded to a User Equipment (UE) in a downlink RRC message. An application layer measurement report (also called QoE report) that the UE Access Stratum (AS) or UE RRC layer receives from the UE's higher layer (application layer) is encapsulated in a transparent container and sent to network in an uplink RRC message. The RAN then forwards the QoE report to a Measurement Collector Entity (MCE).

In 3GPP Release 17, a new study item for “Study on NR QoE management and optimizations for diverse services” for NR has been approved and concluded. The specification work for 3GPP Release 17 is still ongoing. The purpose of the study item is to study solutions for QoE measurements in NR. QoE management in NR will not just collect the quality of experience parameters of streaming services but also consider the typical performance requirements of diverse services (e.g., Augmented Reality (AR)/VR and Ultra-Reliable Low-Latency Communication (URLLC), of which at least VR seems to be covered in 3GPP Release 17). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an Internet Protocol (IP) address of the entity that the collected measurement results (i.e. the QoE reports) should be sent to (often referred to as a MCE, spelled out as Measurement Collector Entity or Measurement Collection Entity, but the entity may sometimes also be referred to as a Trace Collection Entity), and a set of instructions of which type of measurements should be performed and details of how these measurements are to be performed. These instructions are intended for the application layer in the UE and are placed in a “container” which the network entities handling it, e.g., forwarding it to the UE, as well as the UE AS, cannot interpret and do not try to read. The currently specified service types are MTSI and streaming service (DASH), and in 3GPP Release 17, at least service type VR will be added. An area scope is defined in terms of cells or network related areas. In UMTS, an area scope is defined as either a list of cells, a list of routing areas or a list of tracking areas. In LTE, an area scope is defined as either a list of cells or a list of tracking areas. In NR, an area scope will be defined as either a list of cells or a list of tracking areas.

QoE, and in particular QoE configuration, comes in two flavors: management-based (m-based) QoE configuration and signaling-based (s-based) QoE configuration. In both cases, the QoE configuration originates in the OAM system or some other administrational entity, e.g., dealing with customer satisfaction. All these entities are in this document referred to as the OAM system (where the OAM system also contains further entities).

With m-based QoE, the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and fulfills any other relevant condition, such as supporting the concerned application/service type) and sends the m-based QoE configuration to these UEs.

With s-based QoE, the OAM system is interested in collecting QoE measurement results from a specific UE, e.g., because the user of the UE has filed a complaint. The OAM system sends the s-based QoE configuration to the Home Subscriber Server (HSS) (in an Evolved Packet System (EPS)/LTE) or User Data Management (UDM) (in a Fifth Generation System (5GS)/NR), which forwards the QoE configuration to the UE's current CN node, e.g., a Mobility Management Entity (MME) in an EPS/LTE or an Access and Mobility Management Function (AMF) in a 5GS/NR. The CN node then forwards the s-based QoE configuration to the RAN node that serves the concerned UE, and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace Identifier (ID) is associated with each QoE configuration. In NR, the QoE functionality will be logically separated from the Trace functionality, but it will still partly reuse the Trace signaling mechanisms. In NR and LTE, a globally unique QoE reference (formed of MCC (Mobile Country Code)+MNC (Mobile Network Code)+QMC(QoE Measurement Collection) ID, where the QMC ID is a string of 24 bits) will be associated with each QoE configuration. The QoE reference is included in the container with measurement instructions and sent to the RAN (i.e., the Radio base station (gNB) in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE. The measConfigAppLayerId is stored in the UE AS and forwarded in an Attention (AT) Command (which is the type of instructions used in the communication between the UE's modem part and the UE's application layer) together with the service type indication and the container with the measurement instructions.

Reports with collected QoE measurement results (i.e., QoE reports) are sent from the UE application layer to the UE AS, which forwards them to the RAN, which forwards them to the MCE. These QoE measurement results are placed in a “container”, which is uninterpretable for the UE AS and the RAN. QoE reporting can be configured to be periodic or only sent at the end of an application session. Furthermore, the RAN can instruct the UE to pause QoE reporting, e.g., in case the cell/gNB is in a state of overload.

The RAN is not aware of when an application session with an associated QoE measurement session is ongoing, and the UE AS is also not automatically aware of this. To alleviate this session start/stop indications can be introduced, which will be sent from the application layer in the UE to the UE AS and from the UE AS to the RAN. A session stop indication may be implicit in the form of a QoE report sent when the application session and the associated QoE measurement session are concluded.

The RAN may decide to release a QoE configuration in a UE at any time, as an implementation-based decision. Typically, it is done when the UE has moved outside an area configured for the QoE measurements, commonly referred to as the area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

An extension of the QoE framework, which has been studied for 3GPP Release 17 and which is currently being specified in 3GPP is the concept of RAN visible QoE (RVQoE). The regular QoE reports are intended for the MCE, which is an entity outside the RAN, e.g., a part of the OAM system, and the RAN cannot read the QoE reports (at least not according to specification, although gNB/eNB (Evolved Universal Terrestrial RAN (E-UTRAN) NodeB) implementations are not prevented from doing so). In contrast, reported RVQoE metrics are intended for the RAN and are delivered to the RAN in a format that the RAN understands. The RVQoE metrics are derived from the regular QoE metrics, collected and compiled in reports by the UE application layer and delivered to the RAN, so that the RAN may use the reports for various types of optimizations. As an example, when the RAN receives RVQoE reports during an ongoing application session, the RAN can perform adaptive actions to impact the QoE of the concerned application session while the application session is ongoing, such as change various parameters related to the scheduling of the UE and the data flows related to the application session.

QoE measurements are present in many legacy systems. QoE measurements have been specified for LTE and UMTS, and they are being specified for NR. The purpose of the application layer measurements is to measure the end user experience when using certain applications. Currently QoE measurements for streaming services and for MTSI (Mobility Telephony Service for IMS) services are supported.

The solutions in LTE and UMTS are similar with the overall principles as follows. Quality of Experience Measurement Collection enables configuration of application layer measurements in the UE and transmission of QoE measurement result files by means of RRC signaling. Application layer measurement configuration received from O&M or CN is encapsulated in a transparent container, which is forwarded to UE in a downlink RRC message. Application layer measurements received from UE's higher layer are encapsulated in a transparent container and sent to network in an uplink RRC message. The result container is forwarded to a TCE (Trace Collector Entity).

In 3GPP Release 17 a study item for “Study on NR QoE management and optimizations for diverse services” for NR has been carried out. The purpose of the study item was to study solutions for QoE measurements in NR. QoE management in NR will not just collect the experience parameters of streaming services but also consider the typical performance requirements of diverse services (e.g. AR/VR and URLLC).

The measurements may be initiated towards RAN in management-based manner, i.e. from an O&M node in a generic way e.g. for a group of UEs, which may be selected by the RAN, or they may also be initiated in a signaling-based manner, i.e. initiated from CN (on request from the O&M system) to RAN e.g. for a single specific UE. The configuration of the measurement includes the measurement details, which are encapsulated in a container that is transparent to RAN.

When initiated via the core network, the measurement is started towards a specific UE. For the LTE case, the “TRACE START” S1 Application Protocol (S1AP) message is used, which carries, among others, the details about the measurement configuration the application should collect (in the “Container for application layer measurement configuration” Information Element (IE), transparent to the RAN) and the details to reach the trace collection entity to which the measurements should be sent. S1 is the interface between the RAN and the CN in LTE.

Notifications of started and stopped application sessions with associated QoE measurement configurations are introduced, where these notifications are conveyed from the application layer in the UE and to the UE AS (i.e. the radio layers in the UE) and then forwarded to the network. This allows the network (at least the RAN) to be aware of when QoE measurements on an application session are ongoing. It is an implementation decision when the RAN stops the measurements. Typically, it is done when the UE has moved outside the configured area for measurement (also referred to as the area scope). However, this strategy is questioned by the desire to have QoE data that represent complete application sessions.

FIG. 1 is a signaling diagram illustrating the basic signaling (without showing all details) involved in QoE measurement configuration, from the O&M system to the UE. The signaling diagram in FIG. 1 corresponds to the signaling diagram in 3GPP Technical Specification (TS) 28.405 Version (v) 16.0.0, which is labeled “FIG. 4.2.1-1: QMC activation and reporting in LTE”. It provides an overview (without showing all the details) of the signaling involved in QoE measurement configuration, from the O&M system to the UE.

One opportunity provided by legacy solution is also to be able to keep the QoE measurement for the whole application session, even during handover situation, so that reported QoE measurement data cover complete application sessions.

The QoE measurements can be configured in the UE by means of RRC signaling. The configuration is done using the RRC message RRCReconfiguration containing the IE appLayerMeasConfig. The UE starts collecting QoE measurements when the session starts in the application layer and when a report is ready, it is sent to the network in the RRC message MeasurementReportAppLayer. The same RRC messages are used for both regular QoE and RAN visible QoE.

FIG. 2 illustrates configuration and reporting of QoE measurements using RRC signaling.

AT commands are used for communication between the AS (radio) layer and the application layer in the UE. The AT commands are defined in 3GPP TS 27.007V18.2.0 . The AT commands are used in QoE for transferring the configuration from the RRC layer to the application and for transferring reports from the application layer to the RRC layer.

In 3GPP Release 12 (Rel-12), the LTE feature Dual Connectivity (DC) was introduced, to enable the UE to be connected in two cell groups, each controlled by an LTE access node, eNBs, labelled as the Master eNB, MeNB and the Secondary eNB, SeNB. The UE still only has one RRC connection with the network. In 3GPP, the DC solution has since then been evolved and is now also specified for NR as well as between LTE and NR. Multi-connectivity (MC) is the case when there are more than two nodes involved. With the introduction of Fifth Generation (5G), the term MR-DC (Multi-Radio Dual Connectivity, see also 3GPP TS 37.340V17.4.0 ) was defined as a generic term for all dual connectivity options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

Further, in MR-DC, when dual connectivity is configured for the UE, within each of the two cell groups, MCG and SCG, carrier aggregation may be used as well. In this case, within the MCG, controlled by the master node (MN), the UE may use one Primary Cell (PCell) and one or more Secondary Cell(s) (SCell(s)). Within the SCG, controlled by the secondary node (SN), the UE may use one Primary SCell (PSCell, also known as the primary SCG cell in NR) and one or more SCell(s). This combined case is illustrated in FIG. 3. In NR, the primary cell of a master or secondary cell group is sometimes also referred to as the Special Cell (SpCell). Hence, the SpCell in the MCG is the PCell and the SpCell in the SCG is the PSCell.

FIG. 3 is an illustration of dual connectivity combined with carrier aggregation in MR-DC.

There currently exist certain challenge(s).

### SUMMARY

3GPP is discussing QoE in NR-DC scenarios in Release 18 of the 3GPP standard, and it has been agreed that both a Master Node (MN) and a Secondary Node (SN) can configure QoE measurements. A Secondary Node, or a Secondary Cell Group as it is referred to in TS 38.331 version 17.3.0, may not be configured the whole time. The network may configure or de-configure the SCG for various reasons, e.g. depending on the amount of data that is being transmitted to/from the UE or the data rate needed to meet the UE's demands. The release of the SCG is normally done by the MN/MCG (Master Cell Group) and the MN/MCG may not be able to initiate the release the QoE measurements configured by the SN/SCG. This may result in “hanging” QoE measurements in the UE (i.e., measurements configured, but without the possibility to transmit any reports), which will unnecessarily consume UE capacity and UE battery.

It is unclear how to handle the release of the management-based QoE configuration, e.g., if and how this should be coordinated between the MN and the SN. Since the MN decides on the node configuring a UE with an m-based QoE measurement, based on the present art, the MN does not have the visibility into when a configuration is released, and this can especially lead to issues when an SN releases a configuration that MN believes is underway.

Certain aspects of the disclosure and their embodiments may provide solutions to these or other challenges.

Accordingly, in one aspect, there is provided a first method for handling quality of experience (QoE) measurements. The first method is performed by a user equipment (UE). The first method comprises establishing connectivity to a primary network node of a network and a secondary network node of the network and triggering a release, at the UE, of configurations for the QoE measurements. The configurations are configured by the secondary network node. The release is triggered in response to a termination of the connectivity to the secondary network node.

In another aspect, there is provided a second method for handling QoE measurements. The second method is performed by a first network node of a network. The second method comprises establishing connectivity to a UE and triggering a release, at the UE, of configurations for the QoE measurements. The configurations are configured by the first network node. The release is triggered in response to a termination of the connectivity to the UE.

In another aspect, there is provided a UE comprising processing circuitry configured to cause the UE to perform the first method described earlier.

In another aspect, there is provided a network node comprising processing circuitry configured to cause the network node to perform the second method described earlier.

In another aspect, there is provided a computer program comprising instructions which, when executed by processing circuitry of a user equipment, cause the user equipment to perform the method according to the first method described earlier.

In another aspect, there is provided a computer program comprising instructions which, when executed by processing circuitry of a network node, cause the network node to perform the method according to the second method described earlier.

In another aspect, there is provided a computer program product, embodied on a non-transitory machine-readable medium, comprising instructions which are executable by processing circuitry of a user equipment to cause the user equipment to perform the method according to the first method described earlier.

In another aspect, there is provided a computer program product, embodied on a non-transitory machine-readable medium, comprising instructions which are executable by processing circuitry of a network node to cause the network node to perform the method according to the second method described earlier.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a signaling diagram illustrating basic signaling involved in QoE measurement configuration;

FIG. 2 illustrates configuration and reporting of QoE measurements using RRC signaling;

FIG. 3 is an illustration of dual connectivity combined with carrier aggregation in MR-DC.

FIG. 4 is a flow chart illustrating a method in accordance with some embodiments;

FIG. 5 is a flow chart illustrating a method in accordance with some embodiments;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments.

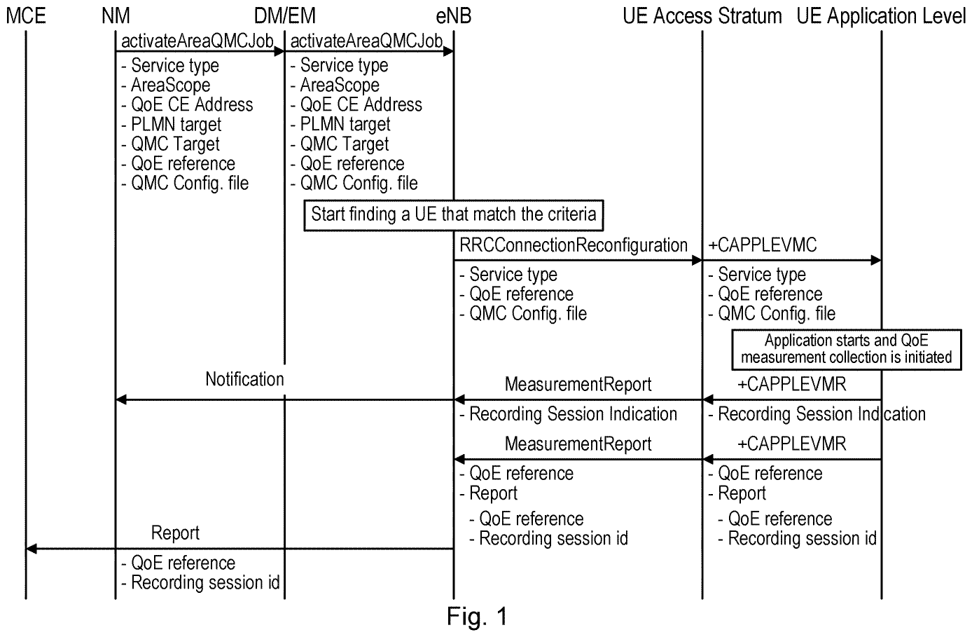

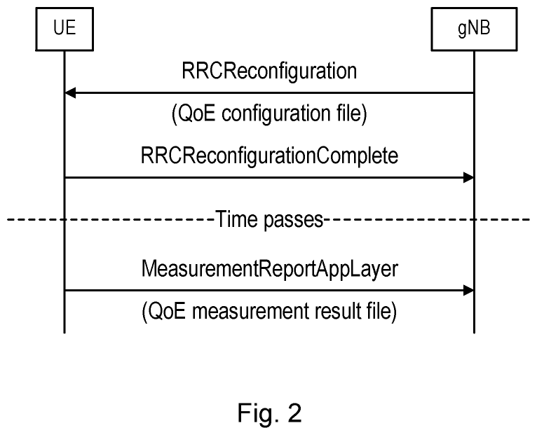

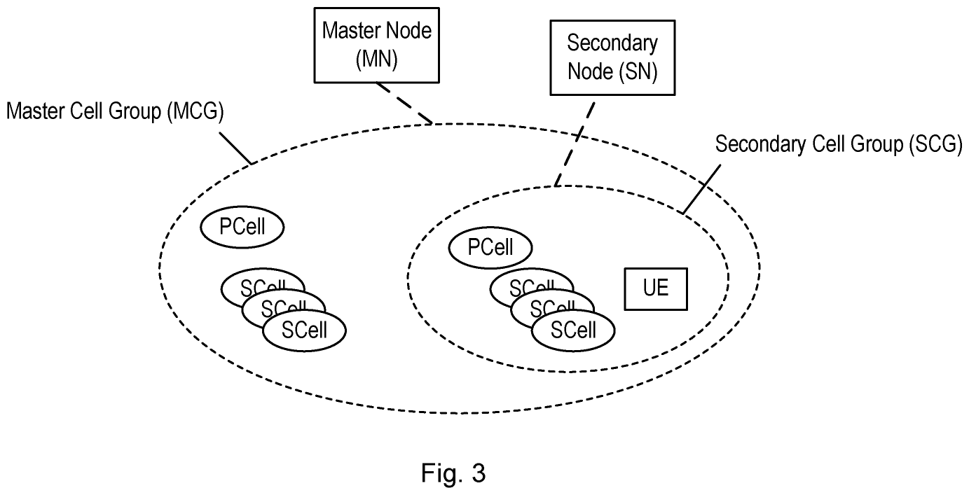

### DETAILED DESCRIPTION

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa.

Other objectives, features and advantages of the enclosed embodiments will be apparent from the following description.

A few points should be made regarding nomenclature for purposes of the present disclosure.

The terms “master node”, “MN”, “master network node”, “MN node”, “primary node”, and “primary network node” can be used interchangeably.

The terms “session start/stop indication” and “start/stop indication” can be used interchangeably.

The disclosure is equally applicable to QoE and RVQoE measurements.

Herein, the application layer in the UE can also referred to as the “UE application layer” or simply the “application layer”.

The terms “QoE report” and “QoE measurement report” can be used interchangeably. The terms “QoE configuration”, “QoE parameters”, “QoE information” and “QoE configuration information”, and “QoE measurement configuration” can be used interchangeably. Similarly, the terms “RVQoE configuration” and “RVQoE measurement configuration” can be used interchangeably. The content of the QoE/RVQUE configuration can be as defined herein and, optionally, to any additional information related to the QoE measurements. The network, the UE AS and the UE application layer may store various parts thereof.

The entity performing the QoE measurements and other actions related to a QoE configuration, such as receiving QoE information from the UE AS, and/or sending QoE information to the UE AS, is an application. The application resides on the application layer in the UE, and hence it is also correct to say that the application layer performs these actions. In the description of the solution, the performer of these various actions is sometimes said to be the application layer and sometimes said to be the application.

The terms “application layer measurement configuration”, “application measurement configuration”, “QoE measurement configuration”, “QoE configuration”, “QoE measurement and reporting configuration”, “RVQUE measurement configuration”, “RVQE configuration”, “RVQoE measurement and reporting configuration” and “QMC configuration” can be used interchangeably. The “QMC configuration file” is not an equivalent term, but instead refers to the part of the QoE configuration consisting of an Extensible Markup Language (XML) file containing instructions of QoE metrics to be collected etc.

While the solutions are described for the interaction between the UE AS and UE application layer when handling/storing QoE information, they may also be applicable to RVQoE information.

All references to the application layer are with respect to the application layer of the UE.

The term “service” is often used as a short notation for “service type”, therefore “service” and “service types” can be seen as interchangeably unless explicitly stated.

The solution proposed in this invention applies to both signaling- and management-based QoE/RVQoE measurements (but may also optionally be restricted to apply to only one of them).

such as an instruction on whether the UE should send session start/stop indications) provides an XML file containing a configuration of QoE measurements to be performed and reported (e.g. indicating QoE metrics to be collected and reported). This XML file is herein referred to with different terms, including at least “QMC configuration file” and “QoE configuration file”.

The functionality in a UE which 3GPP has named Access Stratum (where there is corresponding Access Stratum functionality in the network) is herein referred to in various ways, including “Access Stratum”, “AS”, “UE Access Stratum”, “UE AS”, “Access Stratum layer”, “AS layer”, “UE Access Stratum layer”, “UE AS layer”, and “radio layer”.

The terms “LTE” and “LTE node” imply that a network node that serves the UE is serving the UE by using the LTE radio access technology on the air interface (Uu).

The terms “NR” and “NR node” imply that a network node that serves the UE is serving the UE by using the NR radio access technology on the air interface (Uu).

Certain embodiments are presented with the example of a UE in dual connectivity, and particularly for the case of NR-DC, but embodiments also may apply to any type of multi-radio connectivity and can apply to radio access technologies where the UE is served by more than two connectivity legs.

Certain embodiments proposed herein apply to NR as well as future Radio Access Technologies (RATs) such as Sixth Generation (6G), with the Integrated Access Backhaul Mobile Termination (IAB-MT) a parent backhaul link terminating function and the Integrated Access Backhaul Distributed Unit (IAB-DU) an access service providing function of a relay node.

“Sending reports to a node” may or may not mean that said node is the consumer, i.e., the end destination of the reports. The terms “node”, “network node” and “RAN node” can be used interchangeably herein. Transmission to a MN or transmission to a SN, can mean using the carriers in the MCG and the carriers in the SCG respectively. The terms “session” and “application session” can be used interchangeably. The terms “management-based QoE”, “m-based QoE” and “m-QoE” are used interchangeably.

Parameters/IEs/fields used in Abstract Syntax Notation One (ASN.1) code as well as in procedural text in the 3GPP RRC specification for 5G/NR, i.e. 3GPP TS 38.331 version 17.3.0, are often named with a suffix indicating the number of the release of the 3GPP standard the parameter/IE/field was introduced in (e.g. the suffix “-r17” for a parameter/IE/field introduced in release 17 of the 3GPP standard). Parameters/IEs/fields following this naming convention are typically referred to both with and without the suffix, where the name including the suffix is used in the ASN.1 code (and thus defines the formal name from the ASN.1 compiler's perspective), while the name without the suffix is used in running text, e.g. in field descriptions and procedural text. Relevant examples in the context of this document include the parameters/IEs/fields AppLayerMeasConfig-r17/AppLayerMeasConfig and MeasConfigAppLayer-r17/MeasConfigAppLayer. In this document, both name variants may occur for various parameters/IEs/fields.

Strictly speaking, the session start/stop indications do not refer to the application session, but rather to the QoE measurement session associated with the application session. However, when the terms “session data” or “session data flow” are mentioned, they refer to the data or data flow of the application session with which the QoE measurement session is associated.

In this document, the term “flag” refers to an indication, i.e. a parameter indicating something. An indication referred to as a flag is typically, but not necessarily, an indication that can indicate one of only two possible values, e.g. implemented as a single-bit indicator.

A node that has configured the UE with a QoE/RVQoE configuration is herein referred to as the “owner” of the QoE/RVQoE configuration. Note that the ownership may in some situations be transferred to another node, e.g. during mobility. For instance, if the MN is the owner of the QoE/RVQoE configuration, and the MN is changed due to a change of PCell (e.g. a handover), the ownership is transferred to the new MN. Similarly, as another example, if the SN is the owner of the QoE/RVQOE configuration, and the SN is changed (e.g. due to a SN/SCG change procedure), the ownership may be transferred to the new SN.

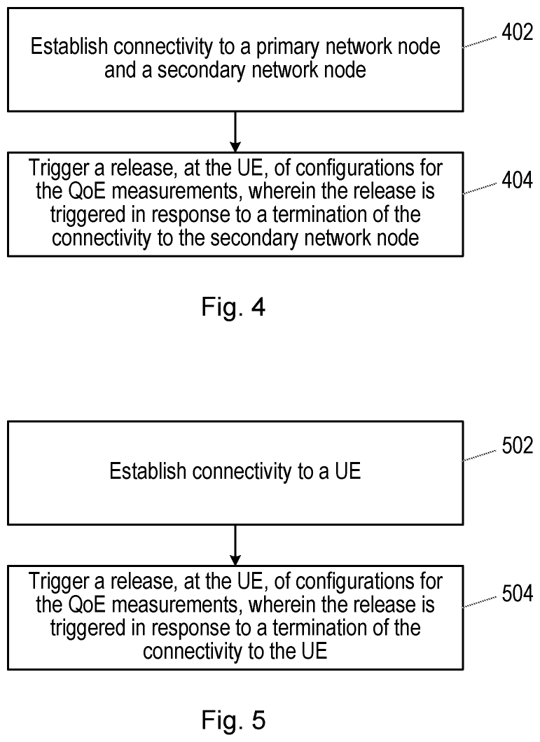

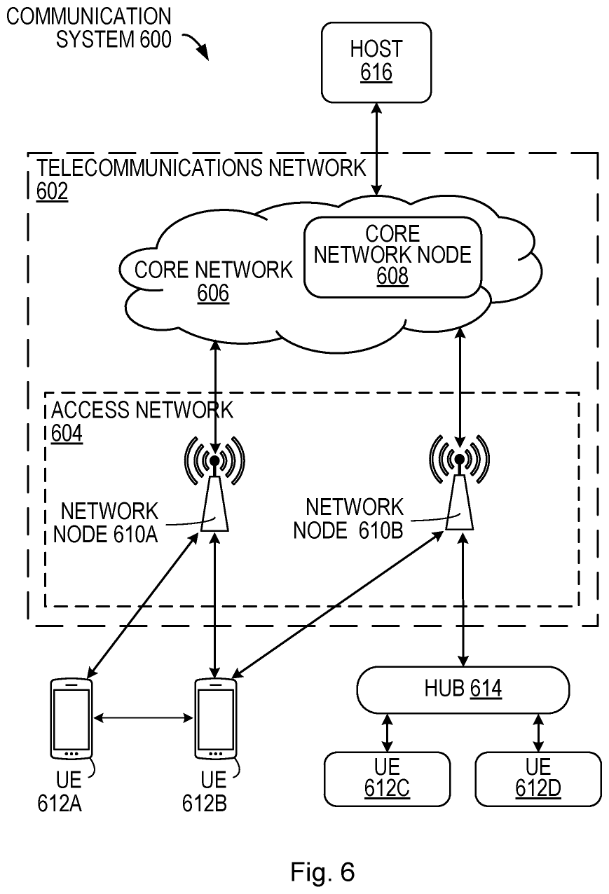

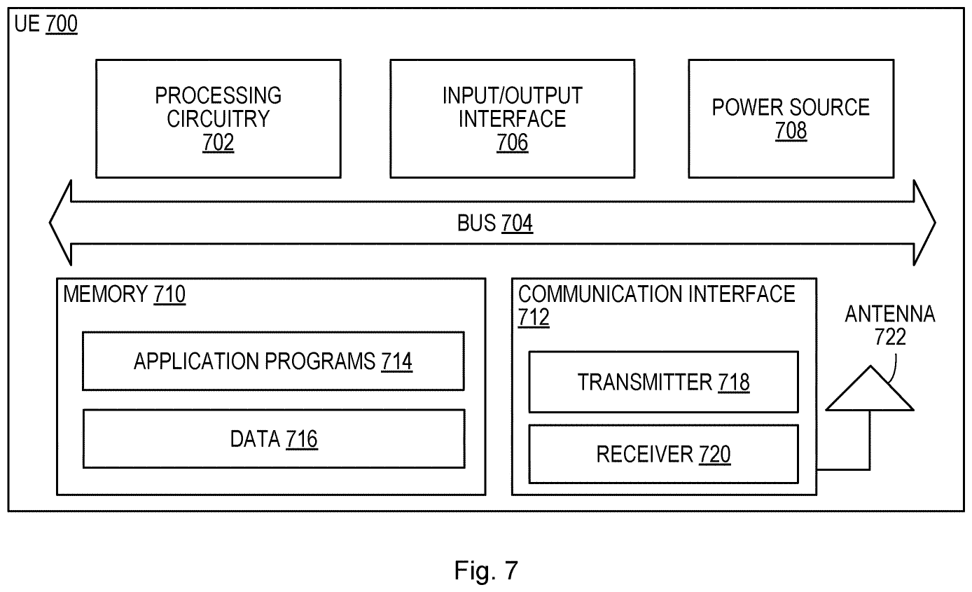

FIG. 4 depicts a first method in accordance with particular embodiments. The first method may be performed by a UE or wireless device (e.g. the UE 612 or UE 700 as described later with reference to FIGS. 6 and 7 respectively). The first method is for handling QoE measurements. The first method begins at step 402 with establishing connectivity to a primary network node of a network and a secondary network node of the network. At step 404, the first method comprises triggering a release, at the UE, of configurations for the QoE measurements. The configurations are configured by the secondary network node. The release is triggered in response to a termination of the connectivity to the secondary network node.

In some embodiments, the termination of the connectivity to the secondary network node may be due to a release of the secondary network node.

In some embodiments, the first method may comprise releasing the secondary network node.

In some embodiments, the first method may comprise receiving a first message comprising information indicative of the termination of the connectivity to the secondary network node.

In some embodiments, the first message may be a radio resource control (RRC) reconfiguration message.

In some embodiments, the first message may be received from the primary network node.

In some embodiments, triggering the release of the configurations may comprise one or both of triggering the release of the configurations from an application layer of the UE and triggering the release of the configurations from an access stratum, AS, layer of the UE.

In some embodiments, triggering the release of the configurations from the application layer of the UE may comprise informing the application layer to release the configurations.

In some embodiments, informing the application layer to release the configurations may comprise indicating, to the application layer, one or more identifiers that identify the configurations.

In some embodiments, triggering the release of the configurations from the application layer of the UE may comprise releasing an access stratum (AS) layer part of the configurations.

In some embodiments, the first method may comprise stopping the QoE measurements for which the configurations configured by the secondary network node are released.

In some embodiments, the first method may comprise initiating a timer for temporarily retaining the configurations after the release of the configurations.

In some embodiments, the first method may comprise upon expiration of the timer, deleting or removing the configurations.

In some embodiments, the first method may comprise triggering the release of the configurations (e.g. upon at least one of the following) after arrival of a next report on the QoE measurements, after arrival of a last report on the QoE measurements in a session; after arrival of an indication that a session, at least in part delivered via the secondary network node, is to stop; after arrival of an indication that a session, at least in part delivered via the secondary network node, is to stop and after sending any pending reports on the QoE measurements; after arrival of an indication that a session is to start after the release; or on expiry of a predefined time period set for retaining the configurations.

In some embodiments, the first method may comprise releasing a signaling radio bearer 5 (SRB 5) in response to release of the secondary network node.

In some embodiments, the SRB5 may be released in response to the first network node receiving an instruction from the second network node to release the SRB5 or the SRB5 may be released on expiry of a predefined time period set for retaining the configurations. In some embodiments, the predefined time period may be set by the UE or the network.

In some embodiments, the first method may comprise handling unsent reports on the QoE measurements for which the configurations configured by the secondary network node are released.

In some embodiments, handling the unsent reports may comprise any one or both of transmitting a second message comprising the unsent reports towards the secondary network node and deleting the unsent reports at the UE.

In some embodiments, the second message may be transmitted towards the secondary network node via the primary network node.

In some embodiments, the second message may be transmitted prior to triggering the release of the configurations.

In some embodiments, the release of the configurations may be triggered in the absence of the primary network node taking over management of the configurations from the secondary network node.

In some embodiments, the first method may comprise determining whether or not the primary network node is taking over management of the configurations from the secondary network node.

In some embodiments, the first method may comprise receiving, from the primary network node, an indication to transmit remaining reports generated according to the configurations to the primary network node instead of the secondary network node.

In some embodiments, the first method may comprise transmitting, towards the primary network node, an indication about an availability of available reports on the QoE measurements.

In some embodiments, the QoE measurements may comprise radio access network visible QUE (RVQoE) measurements.

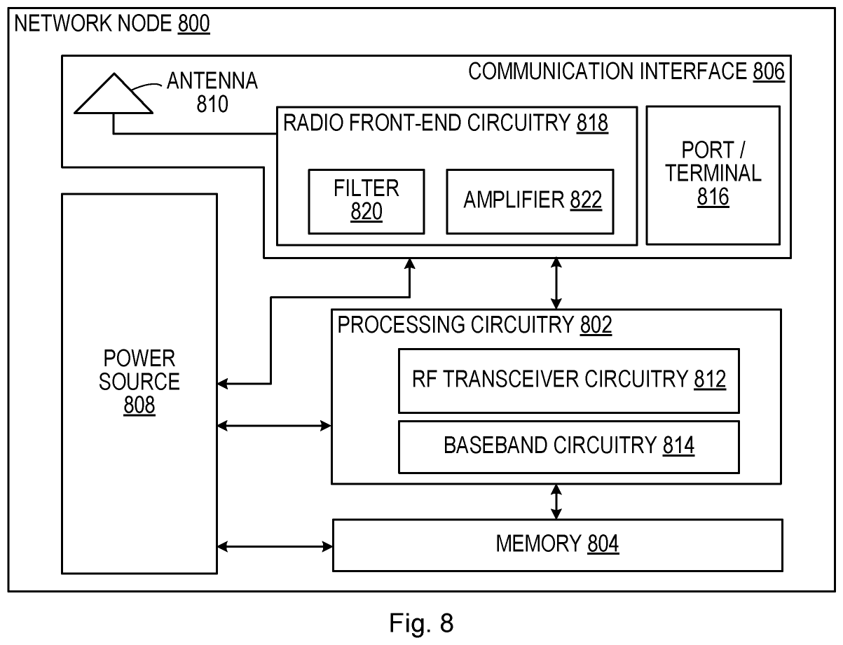

FIG. 5 depicts a second method in accordance with particular embodiments. The second method may be performed by a network node (e.g. the network node 610 or network node 800 as described later with reference to FIGS. 6 and 8 respectively). The second method is for handling QoE measurements. The second method begins at step 502 with establishing connectivity to a UE. At step 504, the second method comprises triggering a release, at the UE, of configurations for the QoE measurements. The configurations are configured by the first network node. The release is triggered in response to a termination of the connectivity to the UE.

In some embodiments, the second method may comprise one or both of: terminating the connectivity to the UE in response to receiving a request to terminate the connectivity to the UE, wherein the request may be received from a second network node of the network for which connectivity is established to the UE; and providing information to the second network node of the network for which connectivity is established to the UE, wherein the information may be about the first network node triggering the release.

In some embodiments, the information may be provided in response to the first network node determining that the release is to be triggered.

In some embodiments, the information may be provided in response to the first network node receiving the request to terminate the connectivity to the UE.

In some embodiments, triggering the release may comprise triggering the release in response to the second network node granting the first network node permission to trigger the release.

In some embodiments, the information may be provided prior to triggering the release and may comprise an indication that the first network node intends to trigger the release. In some embodiments, the information may be provided prior to triggering the release and may comprise a request for the second network node to grant the first network node permission to trigger the release. In some embodiments, the information may be provided subsequent to triggering the release and may comprise an indication that the first network node has triggered the release.

In some embodiments, the information may comprise an indication of whether the release is for only the UE, a plurality of UEs, or all UEs to which connectivity is established for the second network node.

In some embodiments, the second method may comprise receiving, from the second network node, an indication that the first network node is to provide the information.

In some embodiments, providing the information may comprise transmitting Next-Generation Application Protocol (NGAP) or Xn Application Protocol (XnAP) signaling comprising the information.

In some embodiments, the first network node may be a primary network node and the second network node may be a secondary network node. In other embodiments, the first network node may be the secondary network node and the second network node may be the primary network node.

In some embodiments, the QoE measurements may comprise RVQoE measurements.

There is also provided a UE comprising processing circuitry configured to cause the UE to perform the first method described earlier. In some embodiments, the UE may comprise at least one memory for storing instructions which, when executed by the processing circuitry of the UE, cause the UE to operate according to the first method.

There is also provided a network node comprising processing circuitry configured to cause the network node to perform the second method described earlier. In some embodiments, the network node may comprise at least one memory for storing instructions which, when executed by the processing circuitry of the network node, cause the network node to operate according to the second method.

There is also provided a computer program comprising instructions which, when executed by processing circuitry of a user equipment, cause the user equipment to perform the first method according to the first method described earlier.

There is also provided a computer program comprising instructions which, when executed by processing circuitry of a network node, cause the network node to perform the second method according to the second method described earlier.

There is also provided a computer program product, embodied on a non-transitory machine-readable medium, comprising instructions which are executable by processing circuitry of a user equipment to cause the user equipment to perform the first method according to the first method described earlier.

There is also provided a computer program product, embodied on a non-transitory machine-readable medium, comprising instructions which are executable by processing circuitry of a network node to cause the network node to perform the second method according to the second method described earlier.

The disclosure relates to the handling of QoE measurements at SCG release.

The disclosure describes a method for a UE, the method may comprise:
Receiving, from a Secondary Node (SN), the configuration of QoE measurements.
Optionally performing QoE measurements related to the configuration received by SN.
Receiving, a reconfiguration message, e.g. RRCReconfiguration, comprising the reconfiguration from dual connectivity to single connectivity, i.e. the release of the SN.

This message may be received from the MN.
Performing one or multiple of the following actions:
   Stopping any ongoing QoE/RVQUE measurements configured by the SN/SCG.
   Informing the application layer to release the QoE configurations configured by the SN/SCG.
      This may be done by indicating the measConfigAppLayerId of the QoE configurations to be released. In the case of an LTE SCG, the UE may indicate the release of the QoE measurement configuration, if configured by the SCG.
   Releasing the AS layer part of the QoE configurations configured by the SN/SCG.
   Receiving an instruction from the SN or the MN to de-configure (release) the SRB5 and releasing the SRB5 accordingly.
      In one variant, this is conditional to an internal UE timer (see description below in alternative solutions) used for retaining RVQoE/QoE configuration after release of resources associated to the SN, or a network configured timer with the same purpose, i.e., it is done only when such timer expires, or if the timer is re-started due to the re-addition of at least one cell of the same SN whose radio resources were previously released at the UE.
   Handling the unsent QoE reports:
      In one option, transmitting any unsent RVQoE/QoE reports targeted for the SN in a message via the MN, e.g. in an ULInformationTransferMRDC message to the MN for onwards transfer to the SN, e.g. in an RRCTransfer message.
      In another option, deleting any unsent RVQoE/QoE reports targeted for the SN.
      In another option, first transmitting any unsent RVQoE/QoE reports targeted for the SN, then performing the release of the SN/SCG.
Performing the release of the SN/SCG.

The disclosure describes solutions related to ensuring that application layer measurements configured by an SN (Secondary Node) are released in the UE AS and the UE application layer when the UE is reconfigured from dual connectivity to single connectivity, i.e. when the SN is released.

Certain embodiments may provide one or more of the following technical advantage(s). An advantage of the solution is that there will be no “hanging” QoE measurement configurations or QoE measurement reports in the UE after a change from dual to single connectivity. This increases the UE capacity and prolongs the UE battery lifetime. Another advantage is that releasing an, otherwise hanging, QoE measurement configuration will help avoid the UE consuming the allowed budget of maximum number of QoE measurement configuration the UE can be configured with. Another advantage is also a better and more accurate control at the network side, in terms network knowledge of the status at a UE in terms of QoE/RVQoE measurements configured for the UE and the amount/size of QoE/RVQoE reports that can be expected from the UE.

A description of solutions related to the handling of QoE at transmission from dual connectivity to single connectivity will now be described.

There is a method provided for a UE related to the handling of QoE measurements configured by a Secondary Node (SN), when the SN is released by the network i.e., at transition from dual connectivity to single connectivity. The method comprises UE actions for releasing QoE measurement configurations configured by the SN, both in the UE AS layer and in the UE application layer. The method also comprises optional UE actions related to transmission of any unsent QoE reports related to the SN, when the SN is released.

The method also comprises optional SN and MN actions related to handling of the SN QoE configuration and reporting in relation to the release of SN/SCG.

### UE-Related Embodiments

A method for a UE may comprise:
Receiving, from a Secondary Node (SN), the configuration of QoE measurements.
Optionally performing QoE measurements related to the configuration received by SN, e.g., RVQoE measurements whose associated reports are meant to reach the SN.
Receiving, a reconfiguration message, e.g. RRCReconfiguration, comprising the reconfiguration from dual connectivity to single connectivity, i.e. the release of the SN. This message may be received from the MN.
Performing one or multiple of the following actions:
   Stopping any ongoing QoE/RVQUE measurements configured by the SN/SCG.
   Informing the application layer to release the QoE configurations configured by the SN/SCG.
      This may be done by indicating the measConfigAppLayerId of the QoE configurations to be released. In the case of an LTE SCG, the UE may indicate the release of the QoE measurement configuration, if configured by the SCG.
   Releasing the AS layer part of the QoE configurations configured by the SN/SCG.
   Receiving an instruction from the SN or the MN to de-configure (release) the SRB5 and releasing the SRB5 accordingly.
      In one variant, this is conditional to an internal UE timer (see description below in alternative solutions) used for retaining RVQoE/QoE configuration after release of resources associated to the SN, or a network configured timer with the same purpose, i.e., it is done only when such timer expires, or if the timer is re-started due to the re-addition of at least one cell of the same SN whose radio resources were previously released at the UE.
   Handling the unsent Qoe reports:
      In one option, transmitting any unsent RVQoE/QoE reports targeted for the SN in a message via the MN, e.g. in an ULInformationTransferMRDC message to the MN for onwards transfer to the SN, e.g. in an RRCTransfer message.
      In another option, deleting any unsent RVQoE/QoE reports targeted for the SN/SCG.
      In another option, first transmitting any unsent RVQoE/QoE reports targeted for the SN, then performing the release of the SN/SCG.
      In another option, deleting any unsent RVQoE report, but transmit (to the MN) any unsent QoE reports, which were produced by QoE/RVQUE measurements configured by the SN/SCG.
      In another option, deleting any unsent QoE report, but transmit (to the MN) any unsent RVQoE reports, which were produced by QoE/RVQOE measurements configured by the SN/SCG.
      In another option, which can be combined with the preceding ones, the UE transmits or deletes any unsent RVQoE/QoE reports targeted for the SN upon expiration of a timer used to let the UE temporarily retain the RVQoE/QoE configuration.
      As a further option, in all of the above options where any QoE reports and/or RVQoE reports produced by QoE/RVQoE measurements configured by the SN/SCG are sent to the MN/MCG, the UE sends these reports to the MN/MCG only if a certain condition is fulfilled, where the condition may be:
         that the MN or the SN has requested the UE to do so,
         that the MN has taken over the “ownership” of the QoE/RVQoE configuration,
         that at least one of the Ue's MCG cell(s) is within the area scope of the QoE/RVQoE Configuration.
Performing the release of the SN/SCG.

In some alternative UE embodiments:
Possibly, receiving an indication from the MN that the MN is taking over the “ownership” of one or more of the SN's QoE/RVQoE configurations.
In one option, the QoE configuration includes a parameter, which makes the UE understand that, upon release of the SN connectivity leg, the UE AS should start a timer for retaining the RVQoE configuration as soon as the SN resources are released at the UE AS, and release the RVQoE configuration when the timer expires.
Possibly, determining itself regarding a QoE/RVQoE configuration previously configured by the SN (and thus “owned” by the SN), e.g. based on fulfillment of a condition, that the MN takes over the “ownership” of the QoE/RVQoE configuration (which also may imply that any unsent, as well as future, QoE reports and/or RVQUE reports for this QoE/RVQoE configuration should be sent to the MN). If the UE is aware of the area scope, such a condition may e.g. be that at least one of the UE's MCG cell(s) is within the area scope of the QoE/RVQoE configuration. In this option, the area scope known by the UE may be the area scope information the RAN has received, e.g. from an OAM node, and which the RAN has forwarded to the UE AS (e.g. so that the UE AS can monitor the UE's location in relation to the area scope when the UE is in RRC_INACTIVE or RRC_IDLE state), or a LocationFilter parameter the UE application layer has received in a QMC configuration file (and which the UE may useh as the area scope associated with the QoE configuration e.g. when the UE is in RRC_INACTIVE or RRC_IDLE state).
Possibly, receiving an indication from the MN to transmit the remaining reports generated according to SN QoE/RVQoE configuration, to the MN instead of SN upon UE receiving RRCReconfiguration message to release SN.
Performing one or multiple of the following actions in relation to stopping any ongoing QoE/RVQoE measurements configured by the SN/SCG.
   The UE AS initiating an internal timer, or a network configured timer (e.g., a Timer_PendingRVQoEConfiguration) used to temporarily retain RVQoE/QoE configuration after the releasee of SN/SCG resources. The UE AS, upon expiration, determines to delete/remove the RVQoE/QoE configuration associated to the SN (the UE AS sending an AT command to the UE application layer to release the RVQoE/QoE configuration)
   The UE AS waiting for arrival of the next RVQoE report to be sent to the SN, and/or arrival of the next QoE report (from UE application layer to UE AS) and releasing the SN associated RVQoE configuration right after that
   The UE AS waiting for arrival of the last RVQoE report of the session, to be sent to the SN, and/or for arrival of the last QoE report of the session (from UE application layer) and releasing the SN associated RVQoE/QoE configuration right after that.
      Optionally, the UE AS or the UE application layer marking the last RVQoE report, so that the RAN knows that this is the last RVQoE report.
      Optionally, reception by the UE AS of a session stop/end indication from the UE application layer informs the UE AS that no more RVQoE reports or QoE reports will arrive from the UE application layer.
   The UE AS waiting for arrival of the session stop indication associated to an ongoing session of an application, where the session was at least in part delivered via the SN, and then release the SN associated RVQoE/QoE configuration
   The UE AS waiting for arrival of the session stop indication associated to an ongoing session of an application, where the session was at least in part delivered via the SN, send any pending RVQoE/QoE reports associated to SN to the MN, and then release the SN associated RVQoE/QoE configuration
   The UE AS waiting for arrival of a session start indication, arriving at the UE AS from the UE application layer after the SN/SCG release (hence, indicating that the session has been initiated and it is not carried by the SN) and releasing the RVQoE/QoE configuration pertaining to the SN after that
   The UE AS waiting for expiration of a timer monitoring the QoE/RVQUE configuration retention at the UE after QoE/RVQoE configuration is received (at the UE AS or at the UE application layer), without receiving any QoE/RVQUE reports from the UE application layer (e.g., 48 hours) and releasing the SN-related QoE/RVQoE configuration.
After the SN release, possibly sending an indication to the MN about the availability of buffered/available QoE/RVQoE reports (if the UE received pauseReporting indication (set to “true”) from the SN).

### SN-Related Embodiments

There is provided a method for a network node operating in dual connectivity, a Secondary Node (SN), the method may comprise:
Transmitting, to a UE, the configuration of RVQoE/QoE measurements.
   In some variants, in case the UE received the configuration from the MN, receiving an indication from the MN that the “ownership” of the QoE/RVQUE configuration is transferred to the SN.
   In one option, indicating to the UE to use a timer for temporary retaining the RVQoE/QoE configuration upon release of the SN. This may be an indication to use a timer with a specified start value, or the indication from the SN may comprise a start value. Another variant is that it is specified in the standard that the UE should use a specified timer with a specified start value (in which case the SN does not have to transmit any explicit indication to the UE related to the timer). As a further option, the SN may then maintain a corresponding timer upon release of the SN.
Receiving an instruction for release from a Master Node or initiating a release towards the Master Node. Together with this instruction, the SN may, as one option, receive an indication from the MN that the MN takes over the “ownership” of the QoE/RVQUE configuration.
Possibly sending a pauseReporting indication to the UE upon learning from the MN about the upcoming SN release (or upon the decision to initiate SN initiated SCG release).
Releasing all RVQoE/QoE configurations configured by the SN.
   This step may be omitted if the release of the RVQoE/QoE configuration is delegated to the UE, provided that instructions are provided to the UE (from the network or as specified in normative text of a technical specification) according to which the UE is required to release RVQoE/QoE configured by the SN.
   This step is omitted if the SN has received an indication from the MN that the MN takes over the “ownership” of the QoE/RVQoE configuration, or if this transfer of “ownership” is implicitly understood, e.g. from rule in a standard specification or because a certain condition for such a transfer of “ownership” is fulfilled.
   Optionally, sending to the UE, together with the QoE/RVQoE release instruction, a timer (or a start value for a timer) the UE should use to govern a delayed release (i.e. temporary retention) of the QoE/RVQoE configuration(s).
   Optionally, if the SN has sent to the UE a timer (or a start value for a timer, or an indication to use a specified timer with a specified start value, or if it is specified in the standard that the UE should use a specified timer with a specified start value) governing delayed release, i.e. temporary retention, of the QoE/RVQUE configuration, starting a corresponding timer (in the SN itself) and maintaining the network's QoE/RVQoE configuration information until the time expires.
In parallel, before or after the release of RVQoE/QoE configurations at the UE, de-configuring (releasing) the SRB5 for the UE.
If a timer is used for retaining a pending RVQoE/QoE at the UE when the SN related resources at the UE AS are released, the timer can be re-started if at least one cell of the same SN is added (again) to the UE connection before the timer expires.
Performing the release of the SN/SCG.

### MN-Related Embodiments

There is provided a method for a network node operating in dual connectivity, a Master Node (MN), the method may comprise:
Transmitting, to a UE, the configuration of QoE measurements.
   In one option, indicating to the UE to use a timer for temporary retaining the RVQoE configuration upon release of the SN
   In some variants, in case the UE received the configuration from the MN, receiving an indication from the MN that the “ownership” of the QoE/RVQUE configuration is transferred to the SN.
Receiving a request to release the SN related resources from the SN, or deciding itself to release the SN related resources (e.g. the SCG).
Sending a request to the SN to release the SN related resources, which can explicitly or implicitly indicate to release the RVQoE/QoE configured by the SN.
Possibly, sending an indication to the UE that SN-related QoE/RVQoE configuration should be released.
Possibly sending to the SN, together with the request to release the SN related resources, an indication that the MN takes over the “ownership” of one or more of the SN's QoE/RVQoE configuration(s).

After receiving an indication from a UE that SCG is preferably released, the MN may release the SN and may perform the above-described actions of either taking over the “ownership” of an SN QoE/RVQoE configuration, or releasing the configuration altogether
Optionally, when determining whether to take over the “ownership” of one of the SN's QoE/RVQoE configuration(s), the MN may take one or more of the following into account:
   whether the QoE configuration is management-based or signaling-based,
   any instructions received from the OAM system regarding the possible transfer of ownership of the QoE configuration from the SN to the MN upon release of the SN related resources (where the instruction may have been received together with the QoE configuration),
   whether the MN has at least one cell that is within the area scope of the QoE/RVQoE configuration (where e.g. the MN takes over the “ownership” only if this is the case),
   whether at least one of the UE's MCG cell(s) is within the area scop of the QoE/ RVQoE configuration (where e.g. the MN takes over the “ownership” only if this is the case).
If the MN takes over the “ownership” of the QoE/RVQoE configuration, the MN may optionally request the SN to send the concerned QoE configuration (i.e. the QoE configuration related data stored in the SN, including e.g. the MCE IP address) and/or the concerned RVQoE configuration (i.e. the RVQoE related data stored in the SN) to the MN, and may optionally also instruct the SN to inform the UE that the MN takes over the ownership of the QoE configuration (which e.g. implies that both QoE reports and RVQoE reports should be sent to the MN).

### UE Capabilities

In execution of the proposed system, the UE may indicate to the network that it is capable of reporting according to the variants of this solution.

The UE may indicate its capability in the form of ENUMERATED indication type, where each option contains one standardized variant of the solution.

Alternatively, the capability of supporting different variants of the solution may be indicated in the form of a bitmap, where each bit corresponds to one variant, whereas an example of solution variant could be “capable of understanding a single ENUMERATED field providing instructions for RVQoE reporting”. A bit value of “1” may mean that the variant is supported and value “0” may mean that it is not supported, or vice versa.

Alternatively, the UE may set a binary flag, indicating whether the standardized aspects of this solution. A bit value of “1” may mean that the variant is supported and value “0” may mean that it is not supported, or vice versa.

### Support of QoE Measurements in Dual Connectivity

As part of normative work in the specification of release 18 of the 3GPP standard, the RAN 3 Working Group is discussing the support for QoE and RVQoE measurements in NR-DC scenario. The agreements achieved so far are as follows:
MN is responsible to configure the s-based QoE to UE.
For M-based QoE configuration in NR-DC, coordination between MN and SN is needed.
If the M-based QoE configuration is received by the MN, the MN should make the decision on the UE selection and on which node sends the QoE configuration to the UE
If the M-based QoE configuration is received only by the SN, whether the MN or the SN performs UE selection and sends the QoE configuration to the UE needs to be further discussed.

QoE reports can be transmitted to either MN or SN and the reporting leg (MCG or SCG) can be changed during the application session.

If QoE reports are received by the SN, SN can forward the QoE reports to MCE directly.

RAN3 should discuss and clarify the scenarios for QoE reporting transmitted over SN. Which SRB can be used for QoE reporting in SN depend on RAN2.
WA: MN and SN can generate RVQoE configurations.
MN and SN should coordinate about configuring a dual-connected UE with RVQE measurements. The details of the coordination are For Further Study (FFS).
WA: UE can send RVQoE report to MN, MN then forward the RVQoE report to SN if needed, and vice versa.

In DC, the UE switches the reporting leg based on indication from network, FFS on implicit or explicit way.

RAN3 should discuss which node can command the UE to switch the reporting leg.

If a node has configured the UE with QoE measurements, and the other node is receiving the QoE reports from the UE and forwarding them directly to the MCE, then:

The node that has configured the UE with QoE measurements should indicate the QoE reference to the node that receives the reports and forwards them directly to MCE.
The MN can generate an RVQoE configuration for a UE.
The SN can generate an RVQUE configuration for a UE. FFS whether MN can modify the SN generated RVQoE configuration.
The MN can send an RVQoE configuration to the UE.
The MN can receive RVQoE reports directly from the UE.
The SN can receive RVQoE reports directly from the UE.
Turn the following WA into an agreement: “UE can send RVQoE report to the MN, the MN then forward the RVQoE report to the SN if needed, and vice versa”.
Agree to ensure that the RVQoE report is sent to the node(s) that provide the bearer(s) associated to the corresponding RVQOE measurement result in the RVQoE report.

The coordination between the MN and the SN should support at least the following (details to be further discussed):
Initiation by either the MN or the SN for m-QoE, by the MN for s-QoE.
Coordination for configuring the UE.
Coordination for establishing the SRB for receiving QoE/RVQoE reports.
Indication about switching the reporting leg.

In case of management-based QoE, the MN decides which node to perform the QoE measurement configuration, FFS which node (MN or SN) performs UE selection.

When MN configures a UE with m-based QoE, it may indicate to SN: the QoE Reference, the MCE IP address. FFS for other information (e.g., RRC ID)

When SN receives an m-based QoE measurement configuration, MN may be aware that SN has received an m-based QoE measurement configuration. It may be ensured that the MN is (e.g. always) notified that SN would like to configure an m-based QoE measurement.

WA: SN can send an RVQoE configuration to the UE. FFS whether SN can send RVQoE configuration directly to UE via SRB3 or via split SRB1 or explicit over Xn (if MN can modify RVQoE).

The node which sends the initial RVQoE configuration to UE and the node which sends the legacy QoE configuration to UE may be the same.

There currently exist certain challenges. The RAN 3 working group in 3GPP is currently discussing the MN-SN coordination for the scenario where, for a UE in multi-connectivity (for instance NR-DC), either both the MN or SN serving the UE, or one of them, receives a management-based QoE measurement configuration, and intends to configure the UE with it.

The 3GPP discussions have so far focused on MN-SN coordination for deciding which node will configure the UE with management-based QoE measurements. In general, the discussions in 3GPP assume that the MN decides whether the MN or the SN will configure a UE with a management-based QoE configuration in the following scenarios:
Both the MN and the SN have received the management-based QoE configuration.
Only the SN has received the management-based QoE configuration.
Only the MN has received the management-based QoE configuration.

Embodiments include proposed methods for the MN and SN to coordinate with respect to the release of a management-based QoE measurement configuration in one of the two nodes. Embodiments can include the coordination between the MN and the SN, the conditions upon which the release can be requested by one node, and actions by the second node in response to that request.

Certain embodiments may provide one or more of the following technical advantages. Embodiments can enable the MN-SN coordination for the release of a management-based QoE measurement configuration at a UE. Informing the other node of release of QoE measurements enables the other node to take actions accordingly, e.g., for the other node to configure m-based QoE measurements for the UE. The release of a configuration can be an important part of QoE management, similar to configuring the UE with measurements. Described embodiments not only enable a controlled release of management-based QoE measurements, but also in the exchange of other parameters of interest that facilitate in continuity of QoE measurements, indication of causes, and the possibility to perform the disclosed negotiation for groups or all the of UEs for which the QoE configuration is being released.

One general scenario involves two RAN nodes (first and second network node), which may act as the MN or the SN for one or more UEs. Note that, in this scenario both nodes are involved in providing dual connectivity (e.g., NR-DC connectivity) to a UE. If the same two nodes jointly serve several UEs, an SN for one UE may be an MN for another UE and vice versa.

The following cases are considered:
Both the first and the second network node received a management-based (m-based) QoE configuration from the OAM or another entity external to the RAN and the CN, or
Only one of them has received it.

In any case, the nodes have coordinated about which one of them should send the configuration to the UE, and to which of the network nodes the reports will be sent, before being forwarded to the measurement collection entity (MCE). After the coordination, the m-based QoE measurement configuration is sent to the UE, and the UE is configured with measurement configuration and with respect to where (i.e., to which network node) to send the reports.

Certain embodiments are described with the example of one m-based QoE configuration but is equally applicable to any number of m-based QoE configurations.

One embodiment is presented below with an example of the first network node being the SN and the second network node being the MN, but it is also applicable in the opposite case. Also, in the following example, the terms “first network node” and “SN” are used interchangeably. Also, the terms “second network node” and “MN” are also used interchangeably.

There is provided a third method performed by an SN and MN for releasing QoE configurations. At an optional step, the SN may initially receive an indication from the MN that the SN shall inform the MN of any release of m-based QoE configurations. The request may comprise or be associated with further information of what the SN shall transmit to the MN in case of release of QoE configurations. At step 1, SN decides that it wants to release (i.e., de-activate or de-configure) the m-based QoE configuration at the UE. At step 2, the SN indicates to the MN that it is planning to release, or that it wants to release (e.g., requests permission to release), or that it has already released the m-based QoE configuration to the UE. At step 3, the MN makes a decision. At step 4, the SN receives from the MN the MN's decision. At step 5, the SN acts accordingly.

Various embodiments and variations of the third method and the steps are will now be described.

### Step 1

The first network node (i.e., the SN) may configure the UE with the m-based QoE measurements, and the SN may decide that it wants to release (i.e., de-activate or de-configure) the m-based QoE configuration at the UE. The reasons/causes for the SN deciding that it wants to release the configuration may be, but are not limited to, any one or more of the following:
The SN is instructed to do so by the OAM or by another network node or network entity.
The SN is in overload.
The leg between the SN and the UE is experiencing bad radio conditions or is undergoing radio link failure (RLF).
The UE has left the area scope. p1 The SN requests the MN to be removed from dual connectivity (the UE context for the UE will be released at the SN).
The SN has received another m-based QoE configuration and selected the UE for using the new QoE configuration.
The SN has received another QoE configuration for the UE that is of higher priority compared to the existing QoE configuration whereas the UE is already configured with a maximum number of allowed QoE configuration for the UE.
A time larger than a certain threshold has elapsed since when the SN paused the reporting associated to the m-based QoE configuration.
The SN paused the reporting associated to the m-based QoE configuration
The SN did not receive/sent any user data to/for the UE for more than a threshold time (e.g., inactivity time at SN)
The SN is aware that MN paused the reporting associated to the m-based QoE configuration.
The SN is aware that MN paused the reporting associated to the m-based QoE configuration for an amount of time larger than a threshold.
The SN resumed the RVQOE and/or the QoE reporting associated to the m-based QoE configuration but no RVQoE nor QoE reports has been received since the time of resume.
The SN is aware that MN resumed the RVQoE/QoE reporting associated to the m-based QoE configuration but no reporting has been received since the time of resume
The SN did not receive any QoE reports associated to the m-based QoE configuration in question, or the SN did not receive any RVQoE report associated to the RVQoE configuration derived from the m-based QoE configuration.
The SCG is deactivated,
SN Handover take place from the source SN to the target SN.
The first network node wants to update/modify the QoE configuration updated/modified QoE configuration comes from OAM.
UE transferred from the RRC CONNECTED to either of the non-CONNECTED states, and the initially configured m-based QoE configuration was not meant for the non-RRC_CONNECTED states.
SN Handover takes place from gNB to eNB (from a node supporting QoE measurements to the node not supporting QoE measurements).
When the SN receives the RVQoE measurement reports pertaining to the m-based QoE configuration and determines that the quality of experience that a UE/a group of UEs is experiencing is too low.
The SN receives an indication from the MN that: MN will be taking over the configuration/reconfiguring the UE with the same m-based QoE configuration.
The UE leaves the application session associated to the configured m-based QoE configuration.
The application session associated with the m-based QoE configuration stops.
The SN receives an indication from the MN that the m-based QoE configuration needs to be released due to an incoming s-based QoE configuration received by the MN for the same UE that takes precedence over the existing m-based QoE configuration.
The SN had initially configured the UE with m-based QoE so that it could also configure RVQoE measurements for the UE, and later decides to deconfigure the RVQoE measurements.
The SN has determined that another UE would be a better target for the m-based QoE configuration than the current UE, and the SN's “quota” is full for the m-based QoE configuration, so when sending the QoE configuration to the other UE, the QoE configuration in the current UE needs to be released (where the “quota” may be a number of UEs or a fraction of the UEs, which may be determined based on gNB implementation (i.e. the SN's implementation) or an instruction from another entity/node, e.g. the entity/node that send the m-based QoE configuration to the SN).
The SN has determined that the UE is a bad choice of UE for this m-based QoE configuration, e.g., because no application session of the service type associated with the m-based QoE configuration has been started for a long time.
The SN receives an s-based QoE configuration for the same UE, e.g., when the UE reports poor quality of experience and as a response OAM sends an s-based configuration.
The SN detects that an MN change (without a potential change of SN) is under way. While the SN may not want to implicitly release all the m-based QoE configuration for UE's served together with the original MN, however, the SN may want to validate the existing/ongoing m-based QoE configurations with the new MN. The SN may indicate this via a cause value to the new MN.

### Step 2

In one option, the SN may initially receive an indication from the MN that the SN shall inform the MN of any release of m-based QoE configurations. The request may comprise or be associated with further information of what the SN shall transmit to the MN in case of release of QoE configurations.

The SN may indicate to the MN that it is planning to release, or that it wants to release (e.g., requests permission to release), or that it has already released the m-based QoE configuration to the UE. The indication may be implemented by means of an enhancement of existing or newly defined UE-or non-UE associated NGAP or XnAP signalling, and may contain one or more of the following:
An indication of whether the SN has already released the configuration or whether it intends to do it, or whether it requests the permission from the MN to do so.
An indication of whether the configuration is or is being or is intended to be released for all UEs jointly served with the MN, or only for some UEs, or only the indicated UE.
If the indication concerns a single UE, UE associated inter-node signaling (e.g., XnAP) may be used, while non-UE associated inter-node signaling is used when the indication concerns multiple (including all) UEs.
ID(s) of the UE(s) for which the configuration is or is being or is intended to be released.
   a. Alternatively, the indication may state “all UEs”.
   b. In some variants, the indication may pertain to all the jointly served UEs for which the node serves as the SN.
   c. In some variants, the indication may pertain to all the jointly served UEs which the UE configured with the m-based QoE configuration in question.
The QoE reference(s) and/or the measConfigAppLayerId(s) of the configuration(s) that is(are) being released.
An indication that SRB3 and/or SBR5 for a UE (or “all UEs”, or “any UE”) is released or planned to be released.
An indication of whether the measurement configuration is deleted from the SN (i.e., cannot be configured for any more UEs), or whether it is stored (i.e., can be configured for UEs later).
An indication of the reason/cause for releasing the configuration, e.g., by sending a specific cause value to the MN. The cause value may be reuse of an existing cause value or a new cause value.
   a. The indicated reason/cause of the (e.g., intended, wanted, requested, planned, or already performed) release of the m-based MN configuration may be any of the reasons/causes listed in step 1.
   In one alternative, the SN sends the IP address of the MCE to the MN.
   In one alternative, the SN sends to the MN the MCE ID.
   In one alternative, the SN in addition to sending any or all of the above mentioned also sends the RAN-visible QoE configuration parameters to the MN, in case SN had independently configured the UE to report certain RVQDE metrics. The MN may reconfigure its RVQOE configuration and/or instruct a new SN to configure/amend their RVQoE configuration with the UE by comparing it with the previous SN's configuration if the new SN will configure QoE measurements on the UE.

The SN may send a release of the QoE configuration to the UE.

### Step 3

Upon receiving the indication from the SN (indication defined in Step 2), the MN can decide one or more of the following:
In one option, indicate to the SN that it shall inform the MN of any release of m-based QoE configurations. The request to the SN may also comprise or be associated with instructions of what information the SN shall transmit to the MN in case of release of QoE configurations.
To approve the release request suggested by the SN, whereas the MN can decide to release the configuration at the UE by itself, or it can instruct the SN to do that.
To acknowledge the release indicated by the SN.
To acknowledge the information of release received from the SN.
To note the information from the SN (i.e., not transmit any reply to the SN) and determine further actions.
To approve the SN's request to release the m-based QoE configuration and to request it to forward the received reports to the MN
   a. Especially if the SN's reason for releasing QoE configuration is related to SCG failure, SCG deactivation, UE leaving the NR-DC for single connectivity, SN overload.
Upon becoming aware of the reason for the QoE configuration release by the SN, to also release the same QoE configuration.
To approve or reject the request if the cause value indicates that the m-based QoE configuration was configured by a previous MN in addition to indicating the responsible node (see bullet below)
To maintain the m-QoE measurement configuration at the UE and become responsible for it from now on.
   a. In this case, if it is the SN that, until now, forwarded the QoE reports to the MCE, the MN may need to fetch the IP address of the MCE and/or the MCE ID (unless it has already received it from the OAM or from the SN), to be able to forward the reports to the MCE.
   b. Alternatively, the MN may ask the SN for the IP address of the MCE and/or the MCE ID.
The MN's decision depends on the cause of the (e.g., planned, intended, wanted, or requested) release, as indicated by the SN in step 2. Examples:
   a. If the cause is that an OAM entity/node or another RAN external entity/node (e.g. the entity/node that created the m-based QoE configuration or an entity/node that forwarded the m-based QoE configuration to the UE) ordered the SN to release the m-based QoE configuration, the MN accepts (or may not have a choice other than accepting) and approves the release, otherwise the MN may decide to reject the release.
   b. If the cause is that an OAM entity/node or another RAN external entity/node (e.g. the entity/node that created the m-based QoE configuration or an entity/node that forwarded the m-based QoE configuration to the SN) ordered the SN to release the m-based QoE configuration, or if the cause is that the UE has left the area scope in the SN (e.g. none of the SCG cells is in the area scope), the MN accepts (or may not have a choice other than accepting) and approves the release, otherwise the MN may decide to reject the release.
   c. In any situation (e.g. any of the above examples) where the MN accepts or approves the release, or concludes that the SN has already released the m-based QoE configuration, the MN may decide to itself send the m-based QoE configuration to the UE (after the SN has released it), provided that the MN has received the m-based QoE configuration and that at least one of the UE's MCG cell(s) is within the area scope.
The MN's decision depends on whether the MN has received the concerned m-based configuration (e.g., from an OAM entity/node). Examples:
   a. If the MN has received the m-based QoE configuration, the MN accepts/approves the SN's release of the m-based QoE configuration, otherwise the MN may reject the release.
      i. Optionally, this decision may depend on the cause of the (e.g. (planned, intended, wanted, requested, or already performed) release, as indicated by the SN in step 2.
         1. For instance, if the cause of the release is that the release was ordered by an entity/node with authority in the matter, e.g. a OAM entity/node or other RAN external entity/node (e.g. the entity/node that created the m-based QoE configuration or an entity/node that forwarded the m-based QoE configuration to the SN), then the MN accepts/approves the SN's release of the m-based QoE configuration (or concludes that it has already been performed), irrespective of whether the MN has itself received the m-based QoE configuration.
      ii. Optionally, if the MN accepts/approves the SN's release of the m-based QoE configuration (or if the release was already performed), the MN may itself send the m-based QoE configuration to the UE (provided that the MN has received the m-based QoE configuration).
The MN's decision depends on whether the MN itself has the possibility to send the concerned m-based QoE configuration to the UE, where the prerequisites for this is that the MN has received the m-based QoE configuration (e.g., from an OAM entity/node) and that at least one of the UE's MCG cell(s) is within the area scope. Examples:
   a. If the MN can itself send the m-based QoE configuration to the UE, the MN accepts/approves the SN's release of the m-based QoE configuration, otherwise the MN may reject the release.
      i. Optionally, this decision may depend on the cause of the (e.g. (planned, intended, wanted, requested, or already performed) release, as indicated by the SN in step 2.
         1. For instance, if the cause of the release is that the release was ordered by an entity/node with authority in the matter, e.g. a OAM entity/node or other RAN external entity/node (e.g. the entity/node that created the m-based QoE configuration or an entity/node that forwarded the m-based QoE configuration to the SN), then the MN accepts/approves the SN's release of the m-based QoE configuration (or concludes that it has already been performed), irrespective of whether the MN has the possibility to itself send the m-based QoE configuration to the UE.
      ii. Optionally, if the MN accepts/approves the SN's release of the m-based QoE configuration (or if the release was already performed), the MN may itself send the m-based QoE configuration to the UE (provided that the prerequisites for it to do so are fulfilled).

In one embodiment, the MN may learn that the SN has released the configuration by means of cause value in an MN-SN coordination failure message, sent from the SN to the MN as a response to an MN-SN coordination request for QoE.

### Step 4

The MN may respond to the SN, indicating to the SN its decision, as described in step 3, and the SN may act accordingly (step 5).

Further embodiments include proactive coordination of m-based QoE configuration release in conjunction with the configuration coordination;, and indication of collective release of m-based QoE configuration

Proactive Coordination of m-Based QoE Configuration Release in Conjunction with the Configuration Coordination

Already during the coordination of the sending of the m-based QoE configuration to the UE (which in the target scenario results in the SN sending the m-based QoE configuration to the UE), the MN and the SN may perform some proactive coordination actions with regards to a possible subsequent situation where the SN wants, intends or plans to release the m-based QoE configuration (e.g. because the SN receives or detects something that triggers the SN to want, intend or plan to release the m-based QoE configuration). (Such a situation is henceforth referred to as a “release situation”.)

To this end, in conjunction with the coordination of the sending of the m-based QoE configuration to the UE, the MN may perform one or more of the following actions:
Instruct the SN to, when the release situation arises, perform one or more of the following:
   a. Send a message to the MN requesting approval to release the m-based QoE configuration in the UE.
      i. The instruction may further include that the SN should indicate the cause of the release situation.
   b. Send a message to the MN informing that the SN will release the m-based QoE configuration in the UE.
      i. The instruction may further include that the SN should indicate the cause of the release situation.
   c. Send a message to the MN informing that the SN has released the m-based QoE configuration in the UE.
      i. The instruction may further include that the SN should indicate the cause of the release situation.
Inform the SN that it is entirely the SN's decision whether and when to release the m-based QoE configuration in the UE.
   a. The MN may also instruct the SN to inform the MN if/when the SN releases the m-based QoE configuration in the UE.
      i. This instruction may include that the SN shall indicate the cause of the release when it informs the MN of the release.
   b. The MN may use this option (i.e., to leave to the SN to decide whether and when to release the m-based QoE configuration in the UE) e.g.:
      i. when the MN has not received the m-based QoE configuration, or
      ii. when none of the UE's MCG cell(s) is within the area scope, or
      iii. when none of the MN's cells is within the area scope, or
      iv. when none of the MN's cells that neighbor a cell of the SN is within the area scope.
Inform the SN that if the cause of the release situation is one of a certain set of causes, it is entirely the SN's decision whether and when to release the m-based QoE configuration in the UE.
   a. The certain set of causes may include e.g.:
      i. the OAM entity/node or another RAN external entity/node (e.g., the entity/node that created the m-based QoE configuration or an entity/node that forwarded the m-based QoE configuration to the SN) ordered the SN to release the m-based QoE configuration,
      ii. the UE has left the area scope in the SN (e.g., none of the SCG cells is in the area scope).
   b. For cases where the cause is not one of the certain set of causes, the MN may further instruct the SN to, when the release situation arises, perform one or more of the following:
      i. Send a message to the MN requesting approval to release the m-based QoE configuration in the UE.
         1. The instruction may further include that the SN should indicate the cause of the release situation.
      ii. Send a message to the MN informing that the SN will release the m-based QoE configuration in the UE.
         1. The instruction may further include that the SN should indicate the cause of the release situation.
      iii. Send a message to the MN informing that the SN has released the m-based QoE configuration in the UE.
         1. The instruction may further include that the SN should indicate the cause of the release situation.
Instruct the SN to not release the m-based QoE configuration, irrespective of what triggers for such release that the SN might detect.
   a. The instruction may further include that the SN should inform the MN when a release situation has arisen and which the cause for it is.
Instruct the SN to not release the m-based QoE configuration if the cause of a release situation is one of a certain set of causes.
   a. For other causes of the release situation the MN may indicate further instructions, e.g., to send a message to the MN requesting approval for the SN to release the m-based QoE configuration.
   b. When the cause of the release situation is one of the certain set of causes, and the SN as per the instruction, does not release the m-based QoE configuration, the instruction may further include that the SN should inform the MN that the release situation has occurred and which the cause of it is.
Instruct the SN that for different disjoint sets of causes of a release situation, the SN should perform the following actions:
   a. If the cause of the release situation is one of a first set of causes, the SN should refrain from releasing the m-based QoE configuration.
      i. Optionally, the SN should inform the MN that the release situation occurred.
         1. This informing of the MN may be selective based on the cause (as instructed by the MN).
   b. If the cause of the release situation is one of a second set of causes, the SN should send a message to the MN requesting approval for the SN to release the m-based QoE configuration.
   c. If the cause of the release situation is one of a third set of causes, the SN can make its own decision on whether or when to release the m-based QoE configuration.
      i. Optionally, the SN should inform the MN of the release and the cause thereof (as instructed by the MN).
         Indication of Collective Release of m-Based QoE Configuration

Another embodiment is indication of collective release of m-based QoE configuration.

In some variants, an indication to the MN that the SN has released/intends to release an m-based QoE configuration for a UE, may serve as an implicit indication to the MN that the release has been done/is intended to be done for all the UEs that the SN has configured with the m-based configuration in question.

In some variants, the SN may indicate to the MN that it has released/intends to release all m-based configurations for a particular UE.

There is also provided a fourth method performed by a UE for releasing QoE configurations. The fourth method comprises being configured by a network node with m-based QoE measurements. The fourth method comprises receiving a communication to release (i.e. de-activate or de-configure) the m-based QoE configuration. The fourth method comprises releasing the m-based QoE configuration.

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 602 includes one or more Open-RAN (ORAN) network nodes. An ORAN network node is a node in the telecommunication network 602 that supports an ORAN specification (e.g., a specification published by the O-RAN Alliance, or any similar organization) and may operate alone or together with other nodes to implement one or more functionalities of any node in the telecommunication network 602, including one or more network nodes 610 and/or core network nodes 608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 6, the hub 614 communicates with the access network 604 to facilitate indirect communication between one or more UEs (e.g., UE 612c and/or 612d) and network nodes (e.g., network node 610b). In some examples, the hub 614 may be a controller, router, a content source and analytics node, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs). The processing circuitry 702 may be operable to provide, either alone or in conjunction with other UE 700 components, such as the memory 710, UE 700 functionality.

The processing circuitry 702 may be configured to cause the UE 700 to perform the first method described herein (e.g. as described with reference to FIG. 4), the fourth method as described herein, or any other method described herein in relation to the UE.

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a Universal Subscriber Identity Module (USIM) and/or International Subscriber Identity Module (ISIM), other memory, or any combination thereof. The UICC may for example be an embedded UICC (eUICC), integrated UICC (iUICC) or a removable UICC commonly known as ‘SIM card’. The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In some embodiments, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, a memory 804, a communication interface 806, and a power source 808, and/or any other component, or any combination thereof. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, network node 800 functionality.

The processing circuitry 802 may be configured to cause the network node 800 to perform the second method described herein (e.g. as described with reference to FIG. 5), the third method as described herein, or any other method described herein in relation to the network node.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

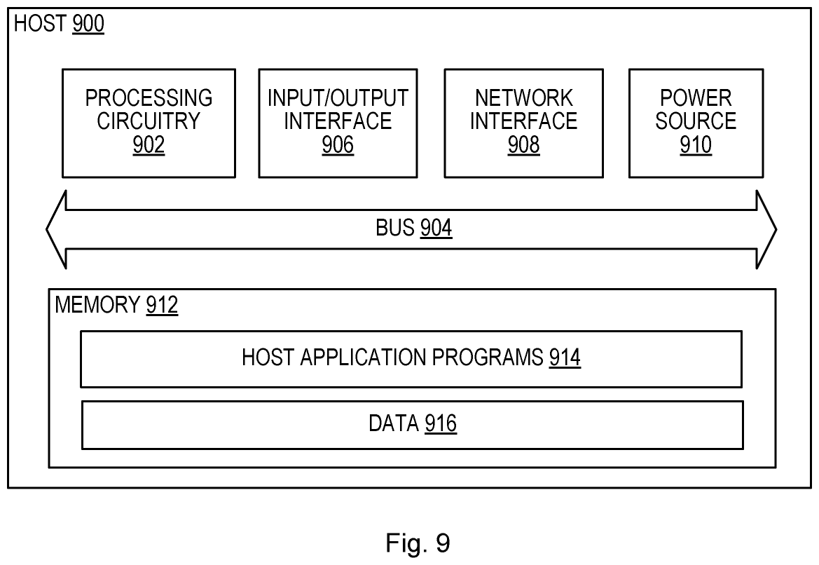

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

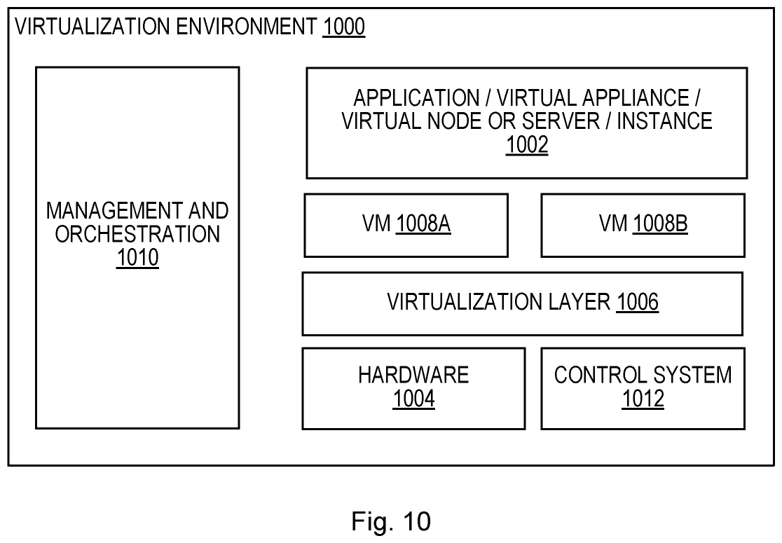

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1000 includes components defined by the O-RAN Alliance, such as an O-Cloud environment orchestrated by a Service Management and Orchestration Framework via an O-2 interface.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

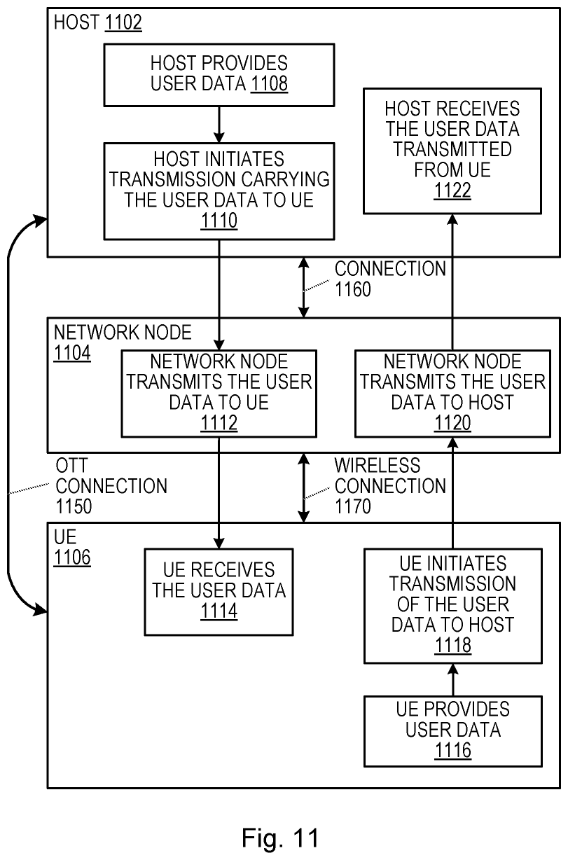

FIG. 11 shows a communication diagram of a host 1102 communicating via a network node 1104 with a UE 1106 over a partially wireless connection in accordance with some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the data rate, latency, and power consumption, and thereby provide benefits such as reduced user waiting time, better responsiveness, extended battery lifetime.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Other embodiments of the present disclosure are defined in the following numbered statements:

### Group A Embodiments

1. A method performed by a user equipment, UE, for handling quality of experience, QoE, measurements, the method comprising:
   establishing connectivity to a primary network node of a network and a secondary network node of the network; and
   triggering a release, at the UE, of configurations for the QoE measurements, wherein the configurations are configured by the secondary network node and the release is triggered in response to a termination of the connectivity to the secondary network node.
2. The method of embodiment 1, wherein:
   the termination of the connectivity to the secondary network node is due to a release of the secondary network node.
3. The method of embodiment 1 or 2, the method comprising:
   releasing the secondary network node.
4. The method of any of the previous embodiments, the method comprising:
   receiving a first message comprising information indicative of the termination of the connectivity to the secondary network node.
5. The method of embodiment 4, wherein:
   the first message is a radio resource control, RRC, reconfiguration message.
6. The method of embodiment 4 or 5, wherein:
   the first message is received from the primary network node.
7. The method of any of the previous embodiments, wherein:
   triggering the release of the configurations comprises one or both of:
      triggering the release of the configurations from an application layer of the UE; and
      triggering the release of the configurations from an access stratum, AS, layer of the UE.
8. The method of embodiment 7, wherein:
   triggering the release of the configurations from the application layer of the UE comprises informing the application layer to release the configurations.
9. The method of embodiment 8, wherein:
   informing the application layer to release the configurations comprises:
      indicating, to the application layer, one or more identifiers that identify the configurations.
10. The method of any of embodiments 7 to 9, wherein:
   triggering the release of the configurations from the AS layer of the UE comprises releasing an access stratum, AS, layer part of the configurations.
11. The method of any of the previous embodiments, the method comprising:
   stopping the QoE measurements for which the configurations configured by the secondary network node are released.
12. The method of any of the previous embodiments, the method comprising:
   initiating a timer for temporarily retaining the configurations after the release of the configurations.
13. The method of embodiment 12, the method comprising:
   upon expiration of the timer, deleting or removing the configurations.
14. The method of any of the previous embodiments, the method comprising:
   triggering the release of the configurations:
      after arrival of a next report on the QoE measurements;
      after arrival of a last report on the QoE measurements in a session;
      after arrival an indication that a session, at least in part delivered via the secondary network node, is to stop;
      after arrival an indication that a session, at least in part delivered via the secondary network node, is to stop and after sending any pending reports on the QoE measurements;
      after arrival of an indication that a session is to start after the release; or
      on expiry of a predefined time period set for retaining the configurations.
15. The method of any of the previous embodiments, the method comprising:
   releasing a signaling radio bearer, SRB, 5 in response to release of the secondary network node.
16. The method of embodiment 15, wherein:
   the SRB5 is released on expiry of a predefined time period set for retaining the configurations.
17. The method of embodiment 16, wherein:
   the predefined time period is set by the UE or the network.
18. The method of any of the previous embodiments, the method comprising:
   handling unsent reports on the QoE measurements for which the configurations configured by the secondary network node are released.
19. The method of embodiment 18, wherein:
   handling the unsent reports comprises any one or both of:
      transmitting a second message comprising the unsent reports towards the secondary network node; and
      deleting the unsent reports at the UE.
20. The method of embodiment 19, wherein:
   the second message is transmitted towards the secondary network node via the primary network node.
21. The method of embodiment 19 or 20, wherein:
   the second message is transmitted prior to triggering the release of the configurations.
22. The method of any of the previous embodiments, wherein:
   the release of the configurations is triggered in the absence of the primary network node taking over management of the configurations from the secondary network node.
23. The method of any of the previous embodiments, the method comprising:
   determining whether or not the primary network node is taking over management of the configurations from the secondary network node.
24. The method of any of the previous embodiments, the method comprising:
   receiving, from the primary network node, an indication to transmit remaining reports generated according to the configurations to the primary network node instead of the secondary network node.
25. The method of any of the previous embodiments, the method comprising:
   transmitting, towards the primary network node, an indication about an availability of available reports on the QoE measurements.
26. A method performed by a user equipment for releasing a QoE configuration, the method comprising:
   being configured by a network node with m-based QoE measurements;
   receiving a communication to release (i.e., de-activate or de-configure) the m-based QoE configuration; and
   releasing the m-based QoE configuration.
27. The method of any of the previous embodiments, further comprising:
   providing user data; and
   forwarding the user data to a host via the transmission to the network node.

### Group B Embodiments

28. A method performed by a secondary network node for handling quality of experience, QoE, measurements, the method comprising:
   establishing connectivity to a primary network node of a network; and
   triggering a release, at the secondary network node, of configurations for the QoE measurements, wherein the configurations are configured by the secondary network node and the release is triggered in response to a termination of the connectivity to the primary network node.
29. A method performed by a first network node (SN) for releasing a QoE configuration, the method comprising:
   (optional) sending to a UE an m-based QoE configuration;
   (optional) receiving an indication from the MN that the SN shall inform the MN of any release of m-based QoE configuration, wherein the request may comprise or be associated with further information of what the SN shall transmit to the MN in case of release of QoE configurations;
   deciding that it wants to release (i.e., de-activate or de-configure) the m-based QoE configuration at the UE;
   indicating to the MN that it is planning to release, or that it wants to release (e.g., requests permission to release), or that it has already released the m-based QoE configuration to the UE;
   receiving from the MN the MN's decision; and
   (optional) performing the action decided by the MN.
30. A method performed by a second network node (MN) for releasing a QoE configuration, the method comprising:
   (optional) sending an indication to the SN that the SN shall inform the MN of any release of m-based QoE configuration, wherein the request may comprise or be associated with further information of what the SN shall transmit to the MN in case of release of QoE configurations;
   receiving an indication from the SN that it is planning to release, or that it wants to release (e.g., requests permission to release), or that it has already released the m-based QoE configuration to the UE;
   making a decision on whether or how the SN should perform the release; and
   indicating to the SN the decision.
31. The method of any of the previous embodiments, wherein the SN's decision to release is based at least in part on one or more of the following:
   the SN is instructed to do so by the OAM or by another network node or network entity;
   the SN is in overload;
   the leg between the SN and the UE is experiencing bad radio conditions or is undergoing radio link failure (RLF);
   the UE has left the area scope;
   the SN requests the MN to be removed from dual connectivity (the UE context for the UE will be released at the SN);
   the SN has received another m-based QoE configuration and selected the UE for using the new QoE configuration;
   the SN has received another QoE configuration for the UE that is of higher priority compared to the existing QoE configuration whereas the UE is already configured with a maximum number of allowed QoE configuration for the UE;
   a time larger than a certain threshold has elapsed since when the SN paused the reporting associated to the m-based QoE configuration;
   the SN paused the reporting associated to the m-based QoE configuration;
   the SN did not receive/sent any user data to/for the UE for more than a threshold time (e.g. inactivity time at SN);
   the SN is aware that MN paused the reporting associated to the m-based QoE configuration;
   the SN is aware that MN paused the reporting associated to the m-based QoE configuration for an amount of time larger than a threshold;
   the SN resumed the RVQoE and/or the QoE reporting associated to the m-based QoE configuration but no RVQoE nor QoE reports has been received since the time of resume;
   the SN is aware that MN resumed the RVQoE/QoE reporting associated to the m-based QoE configuration but no reporting has been received since the time of resume;
   the SN did not receive any QoE reports associated to the m-based QoE configuration in question, or the SN did not receive any RVQUE report associated to the RVQOE configuration derived from the m-based QoE configuration;
   the SCG is deactivated;
   SN Handover take place from the source SN to the target SN;
   the first network node wants to update/modify the QoE configuration updated/modified QoE configuration comes from OAM;
   UE transferred from the RRC CONNECTED to either of the non-CONNECTED states, and the initially configured m-based QoE configuration was not meant for the non-RRC_CONNECTED states;
   SN Handover takes place from gNB to eNB (from a node supporting QoE measurements to the node not supporting QoE measurements);
   when the SN receives the RVQoE measurement reports pertaining to the m-based QoE configuration and determines that the quality of experience that a UE/a group of UEs is experiencing is too low;
   the SN receives an indication from the MN that: MN will be taking over the configuration/reconfiguring the UE with the same m-based QoE configuration;
   the UE leaves the application session associated to the configured m-based QoE configuration;
   the application session associated with the m-based QoE configuration stops;
   the SN receives an indication from the MN that the m-based QoE configuration needs to be released due to an incoming s-based QoE configuration received by the MN for the same UE that takes precedence over the existing m-based QoE configuration;
   the SN had initially configured the UE with m-based QoE so that it could also configure RVQoE measurements for the UE, and later decides to deconfigure the RVQUE measurements;
   the SN has determined that another UE would be a better target for the m-based QoE configuration than the current UE, and the SN's “quota” is full for the m-based QoE configuration, so when sending the QoE configuration to the other UE, the QoE configuration in the current UE needs to be released (where the “quota” may be a number of UEs or a fraction of the UEs, which may be determined based on gNB implementation (i.e. the SN's implementation) or an instruction from another entity/node, e.g. the entity/node that send the m-based QoE configuration to the SN);
   the SN has determined that the UE is a bad choice of UE for this m-based QoE configuration, e.g., because no application session of the service type associated with the m-based QoE configuration has been started for a long time;
   the SN receives an s-based QoE configuration for the same UE, e.g., when the UE reports poor quality of experience and as a response OAM sends an s-based configuration; the SN detects that an MN change (without a potential change of SN) is under way (while the SN may not want to implicitly release all the m-based QoE configuration for UE's served together with the original MN, however, the SN may want to validate the existing/ongoing m-based QoE configurations with the new MN, the SN may indicate this via a cause value to the new MN).
32. The method of any of the previous embodiments, wherein the indicating by the SN comprises one or more of the following:
   an enhancement of existing or newly defined UE-or non-UE associated NGAP or XnAP signalling;
   an indication of whether the SN has already released the configuration or whether it intends to do it, or whether it requests the permission from the MN to do so;
   an indication of whether the configuration is or is being or is intended to be released for all UEs jointly served with the MN, or only for some UEs, or only the indicated UE;
   if the indication concerns a single UE, UE associated inter-node signaling (e.g., XnAP) may be used, while non-UE associated inter-node signaling is used when the indication concerns multiple (including all) UEs;
   ID(s) of the UE(s) for which the configuration is or is being or is intended to be released;
   the QoE reference(s) and/or the measConfigAppLayerId(s) of the configuration(s) that is(are) being released;
   an indication that SRB3 and/or SBR5 for a UE (or “all UEs”, or “any UE”) is released or planned to be released;
   an indication of whether the measurement configuration is deleted from the SN (i.e., cannot be configured for any more UEs), or whether it is stored (i.e., can be configured for UEs later);
   an indication of the reason/cause for releasing the configuration, e.g. by sending a specific cause value to the MN. The cause value may be reuse of an existing cause value or a new cause value;
   the indicated reason/cause of the (e.g., intended, wanted, requested, planned or already performed) release of the m-based MN configuration may be any of the reasons/causes listed in step 1;
   in one alternative, the SN sends the IP address of the MCE to the MN;
   in one alternative, the SN sends to the MN the MCE ID;
   in one alternative, the SN in addition to sending any or all of the above mentioned also sends the RAN-visible QoE configuration parameters to the MN, in case SN had independently configured the UE to report certain RVQUE metrics. The MN may reconfigure its RVQoE configuration and/or instruct a new SN to configure/amend their RVQoE configuration with the UE by comparing it with the previous SN's configuration if the new SN will configure QoE measurements on the UE.
33. The method of any of the previous embodiments, wherein the deciding by the MN comprises one or more of the following:
   indicating to the SN that it shall inform the MN of any release of m-based QoE configurations (the request to the SN may also comprise or be associated with instructions of what information the SN shall transmit to the MN in case of release of QoE configurations);
   approving the release request suggested by the SN, whereas the MN can decide to release the configuration at the UE by itself, or it can instruct the SN to do that;
   acknowledging the release indicated by the SN;
   acknowledging the information of release received from the SN;
   noting the information from the SN (i.e. not transmit any reply to the SN) and determine further actions;
   approving the SN's request to release the m-based QoE configuration and to request it to forward the received reports to the MN, especially if the SN's reason for releasing QoE configuration is related to SCG failure, SCG deactivation, UE leaving the NR-DC for single connectivity, SN overload;
   upon becoming aware of the reason for the QoE configuration release by the SN, to also release the same QoE configuration;
   approving or reject the request if the cause value indicates that the m-based QoE configuration was configured by a previous MN in addition to indicating the responsible node (see bullet below);
   maintaining the m-QoE measurement configuration at the UE and become responsible for it from now on (in this case, if it is the SN that, until now, forwarded the QoE reports to the MCE, the MN may need to fetch the IP address of the MCE and/or the MCE ID (unless it has already received it from the OAM or from the SN), to be able to forward the reports to the MCE, alternatively, the MN may ask the SN for the IP address of the MCE and/or the MCE ID);
   the MN's decision depends on the cause of the (e.g. planned, intended, wanted, or requested) release, as indicated by the SN in step 2;
   if the cause is that an OAM entity/node or another RAN external entity/node (e.g. the entity/node that created the m-based QoE configuration or an entity/node that forwarded the m-based QoE configuration to the UE) ordered the SN to release the m-based QoE configuration, the MN accepts (or may not have a choice other than accepting) and approves the release, otherwise the MN may decide to reject the release;
   if the cause is that an OAM entity/node or another RAN external entity/node (e.g. the entity/node that created the m-based QoE configuration or an entity/node that forwarded the m-based QoE configuration to the SN) ordered the SN to release the m-based QoE configuration, or if the cause is that the UE has left the area scope in the SN (e.g. none of the SCG cells is in the area scope), the MN accepts (or may not have a choice other than accepting) and approves the release, otherwise the MN may decide to reject the release;
   in any situation (e.g. any of the above examples) where the MN accepts or approves the release, or concludes that the SN has already released the m-based QoE configuration, the MN may decide to itself send the m-based QoE configuration to the UE (after the SN has released it), provided that the MN has received the m-based QoE configuration and that at least one of the UE's MCG cell(s) is within the area scope;
   the MN's decision depends on whether the MN has received the concerned m-based configuration (e.g. from an OAM entity/node);
   if the MN has received the m-based QoE configuration, the MN accepts/approves the SN's release of the m-based QoE configuration, otherwise the MN may reject the release;
   optionally, this decision may depend on the cause of the (e.g. (planned, intended, wanted, requested, or already performed) release, as indicated by the SN in step 2, for instance, if the cause of the release is that the release was ordered by an entity/node with authority in the matter, e.g. a OAM entity/node or other RAN external entity/node (e.g. the entity/node that created the m-based QoE configuration or an entity/node that forwarded the m-based QoE configuration to the SN), then the MN accepts/approves the SN's release of the m-based QoE configuration (or concludes that it has already been performed), irrespective of whether the MN has itself received the m-based QoE configuration;
   optionally, if the MN accepts/approves the SN's release of the m-based QoE configuration (or if the release was already performed), the MN may itself send the m-based QoE configuration to the UE (provided that the MN has received the m-based QoE configuration);
   the MN's decision depends on whether the MN itself has the possibility to send the concerned m-based QoE configuration to the UE, where the prerequisites for this is that the MN has received the m-based QoE configuration (e.g. from an OAM entity/node) and that at least one of the UE's MCG cell(s) is within the area scope;
   if the MN can itself send the m-based QoE configuration to the UE, the MN accepts/approves the SN's release of the m-based QoE configuration, otherwise the MN may reject the release;
   optionally, this decision may depend on the cause of the (e.g. (planned, intended, wanted, requested, or already performed) release, as indicated by the SN in step 2, for instance, if the cause of the release is that the release was ordered by an entity/node with authority in the matter, e.g. a OAM entity/node or other RAN external entity/node (e.g. the entity/node that created the m-based QoE configuration or an entity/node that forwarded the m-based QoE configuration to the SN), then the MN accepts/approves the SN's release of the m-based QoE configuration (or concludes that it has already been performed), irrespective of whether the MN has the possibility to itself send the m-based QoE configuration to the UE;
   optionally, if the MN accepts/approves the SN's release of the m-based QoE configuration (or if the release was already performed), the MN may itself send the m-based QoE configuration to the UE (provided that the prerequisites for it to do so are fulfilled);
   in one embodiment, the MN may learn that the SN has released the configuration by means of cause value in an MN-SN coordination failure message, sent from the SN to the MN as a response to an MN-SN coordination request for QoE.
34. The method of any of the previous embodiments, wherein in combination with sending an m-based QoE configuration to a UE, the MN and the SN may perform some proactive coordination actions with regards to a possible subsequent situation where the SN wants, intends or plans to release the m-based QoE configuration, wherein the proactive coordination actions comprises the MN performing one or more of: instruct the SN to, when the release situation arises, perform one or more of the following:
   send a message to the MN requesting approval to release the m-based QoE configuration in the UE, the instruction may further include that the SN should indicate the cause of the release situation;
   send a message to the MN informing that the SN will release the m-based QoE configuration in the UE, the instruction may further include that the SN should indicate the cause of the release situation;
   send a message to the MN informing that the SN has released the m-based QoE configuration in the UE, the instruction may further include that the SN should indicate the cause of the release situation;
   inform the SN that it is entirely the SN's decision whether and when to release the m-based QoE configuration in the UE, the MN may also instruct the SN to inform the MN if/when the SN releases the m-based QoE configuration in the UE, this instruction may include that the SN shall indicate the cause of the release when it informs the MN of the release, the MN may use this option (i.e. to leave to the SN to decide whether and when to release the m-based QoE configuration in the UE) e.g.: when the MN has not received the m-based QoE configuration, or when none of the UE's MCG cell(s) is within the area scope, or when none of the MN's cells is within the area scope, or when none of the MN's cells that neighbor a cell of the SN is within the area scope;
   inform the SN that if the cause of the release situation is one of a certain set of causes, it is entirely the SN's decision whether and when to release the m-based QoE configuration in the UE, the certain set of causes may include e.g.: the OAM entity/node or another RAN external entity/node (e.g. the entity/node that created the m-based QoE configuration or an entity/node that forwarded the m-based QoE configuration to the SN) ordered the SN to release the m-based QoE configuration, the UE has left the area scope in the SN (e.g. none of the SCG cells is in the area scope), for cases where the cause is not one of the certain set of causes, the MN may further instruct the SN to, when the release situation arises, perform one or more of the following: send a message to the MN requesting approval to release the m-based QoE configuration in the UE, the instruction may further include that the SN should indicate the cause of the release situation;
   send a message to the MN informing that the SN will release the m-based QoE configuration in the UE, the instruction may further include that the SN should indicate the cause of the release situation;
   send a message to the MN informing that the SN has released the m-based QoE configuration in the UE, the instruction may further include that the SN should indicate the cause of the release situation;
   instruct the SN to not release the m-based QoE configuration, irrespective of what triggers for such release that the SN might detect, the instruction may further include that the SN should inform the MN when a release situation has arisen and which the cause for it is;
   instruct the SN to not release the m-based QoE configuration if the cause of a release situation is one of a certain set of causes, for other causes of the release situation the MN may indicate further instructions, e.g. to send a message to the MN requesting approval for the SN to release the m-based QoE configuration, when the cause of the release situation is one of the certain set of causes, and the SN as per the instruction, does not release the m-based QoE configuration, the instruction may further include that the SN should inform the MN that the release situation has occurred and which the cause of it is;
   instruct the SN that for different disjoint sets of causes of a release situation, the SN should perform the following actions: if the cause of the release situation is one of a first set of causes, the SN should refrain from releasing the m-based QoE configuration, optionally, the SN should inform the MN that the release situation occurred, this informing of the MN may be selective based on the cause (as instructed by the MN), if the cause of the release situation is one of a second set of causes, the SN should send a message to the MN requesting approval for the SN to release the m-based QoE configuration, if the cause of the release situation is one of a third set of causes, the SN can make its own decision on whether or when to release the m-based QoE configuration, optionally, the SN should inform the MN of the release and the cause thereof.
35. The method of any of the previous embodiments, wherein the notification from the SN to the MN that the SN has released/intends to release an m-based QoE configuration for a UE, may serve as an implicit indication to the MN that the release has been done/is intended to be done for all the UEs that the SN has configured with the m-based configuration in question.
36. The method of any of the previous embodiments, wherein the notification from the SN may indicate to the MN that it has released/intends to release all m-based configurations for a particular UE.
37. The method of any of the previous embodiments, further comprising:
   obtaining user data; and
   forwarding the user data to a host or a user equipment.

### Group C Embodiments

38. A user equipment for handling quality of experience, QoE, measurements, comprising:
   processing circuitry configured to cause the user equipment to perform any of the steps of any of the Group A embodiments; and
   power supply circuitry configured to supply power to the processing circuitry.
39. A network node for handling quality of experience, QoE, measurements, the network node comprising:
   processing circuitry configured to cause the network node to perform any of the steps of any of the Group B embodiments;
   power supply circuitry configured to supply power to the processing circuitry.
40. A user equipment (UE) for handling quality of experience, QoE, measurements, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
41. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
42. The host of the previous embodiment, wherein:
   the processing circuitry of the host is configured to execute a host application that provides the user data; and
   the UE comprises processing circuitry configured to execute a client application associated with the host application to receive the transmission of user data from the host.
43. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
44. The method of the previous embodiment, further comprising, at the network node, transmitting the user data provided by the host for the UE.
45. The method of any of the previous 2 embodiments, wherein the user data is provided at the host by executing a host application that interacts with a client application executing on the UE, the client application being associated with the host application.
46. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
47. The communication system of the previous embodiment, further comprising:
   the network node; and/or
   the UE.
48. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
49. The host of the previous 2 embodiments, wherein:
   the processing circuitry of the host is configured to execute a host application that receives the user data; and
   the host application is configured to interact with a client application executing on the UE, the client application being associated with the host application.
50. The host of the any of the previous 2 embodiments, wherein the initiating receipt of the user data comprises requesting the user data.
51. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
52. The method of the previous embodiment, further comprising at the network node, transmitting the received user data to the host.
53. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.
54. The host of the previous embodiment, wherein the cellular network further includes a network node configured to communicate with the UE to transmit the user data to the UE from the host.
55. The host of the previous 2 embodiments, wherein:
   the processing circuitry of the host is configured to execute a host application, thereby providing the user data; and
   the host application is configured to interact with a client application executing on the UE, the client application being associated with the host application.
56. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
57. The method of the previous embodiment, further comprising:
   at the host, executing a host application associated with a client application executing on the UE to receive the user data from the host application.
58. The method of the previous embodiment, further comprising:
   at the host, transmitting input data to the client application executing on the UE, the input data being provided by executing the host application,
   wherein the user data is provided by the client application in response to the input data from the host application.
59. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
60. The host of the previous embodiment, wherein the cellular network further includes a network node configured to communicate with the UE to transmit the user data from the UE to the host.
61. The host of the previous 2 embodiments, wherein:
   the processing circuitry of the host is configured to execute a host application, thereby providing the user data; and
   the host application is configured to interact with a client application executing on the UE, the client application being associated with the host application.
62. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
63. The method of the previous embodiment, further comprising:
   at the host, executing a host application associated with a client application executing on the UE to receive the user data from the UE.
64. The method of the previous 2 embodiments, further comprising:
   at the host, transmitting input data to the client application executing on the UE, the input data being provided by executing the host application,
   wherein the user data is provided by the client application in response to the input data from the host application.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

### APPENDIX

An example implementation of a solution in 3GPP TS 38.331 v 17.4.0, where the UE actions are described in procedure text is shown here:

### 5.3.5.10 MR-DC Release

The UE shall:
1> as a result of MR-DC release triggered by E-UTRA or NR:
   2> release SRB3, if established, as specified in 5.3.5.6.2;
   2> release measConfig associated with SCG;
   2> if the UE is configured with NR SCG:
      3> release the SCG configuration as specified in clause 5.3.5.4;
      3> release otherConfig associated with the SCG, if configured;
      3> inform upper layers about the release of the application layer measurement configurations associated with the SCG;
      3> discard any application layer measurement report associated with the SCG received from upper layers;
      3> perform the release of SRB 5, if established, as specified in 5.3.5.6.2;
      3> consider itself not to be configured to send application layer measurement report to the SCG.
      3> stop timers T346a, T346b, T346c, T346d, T346e, T346j and T346k associated with the SCG, if running;
      3> release bap-Config associated with the SCG, if configured;
      3> release the BAP entity as specified in TS 38.340 [47], if there is no configured bap-Config;
      3> release iab-IP-AddressConfigurationList associated with the SCG, if configured;
   2> else if the UE is configured with E-UTRA SCG:
      3> release the SCG configuration as specified in TS 36.331 [10], clause 5.3.10.19 to release the E-UTRA SCG;

An example implementation of a solution in 3GPP TS 36.331 v 17.4.0, where the UE actions are described in procedure text is shown here:

### 5.3.10.19 NE-DC (NR-E-UTRA Dual Connectivity) Release

The UE shall:
1> if NE-DC release is triggered by NR:
   2> reset SCG Medium Access Control (MAC), if configured;
   2> for each Radio Link Control (RLC) bearer that is part of the SCG configuration:
      3> perform RLC bearer release procedure as specified in 5.3.10.17 (SRBs) and in 5.3.10.2 (Data Radio Bearers, DRBs);
   2> release the measurement configuration;
   2> inform upper layers to clear any stored application layer measurement configuration associated with the SCG;
   2> discard received application layer measurement report information associated with the SCG from upper layers;
   2> consider itself not to be configured to send application layer measurement report to the SCG;
   2> release the SCG configuration i.e. release the MAC and physical configuration for each cell that is part of the SCG configuration;
   2> stop timer T313 for the corresponding PSCell, if running;
   2> stop timer T307 for the corresponding PSCell, if running.
NOTE: Upon NE-DC release the UE releases all fields configured by the RRCConnectionReconfiguration message.

1-40. (canceled)

41. A method performed by a user equipment, UE, for handling quality of experience (QoE) measurements, the method comprising:
establishing connectivity to a primary network node of a network and a secondary network node of the network; and
triggering a release, at the UE, of configurations for the QoE measurements, wherein the configurations are configured by the secondary network node and the release is triggered in response to a termination of the connectivity to the secondary network node.

42. The method of claim 41, wherein:
the termination of the connectivity to the secondary network node is due to a release of the secondary network node.

43. The method of claim 41, the method comprising:
receiving a first message comprising information indicative of the termination of the connectivity to the secondary network node.

44. The method of claim 43, wherein:
the first message is received from the primary network node.

45. The method of claim 41, wherein:
triggering the release of the configurations comprises one or both of:
triggering the release of the configurations from an application layer of the UE; and
triggering the release of the configurations from an access stratum (AS) layer of the UE.

46. The method of claim 45, wherein:
triggering the release of the configurations from the application layer of the UE comprises informing the application layer to release the configurations.

47. The method of claim 46, wherein:
informing the application layer to release the configurations comprises:
indicating, to the application layer, one or more identifiers that identify the configurations.

48. The method of claim 45, wherein:
triggering the release of the configurations from the application layer of the UE comprises releasing an access stratum (AS) layer part of the configurations.

49. The method of claim 41, the method comprising:
stopping the QoE measurements for which the configurations configured by the secondary network node are released.

50. The method of claim 41, the method comprising:
releasing a signaling radio bearer (SRB) 5 in response to release of the secondary network node, wherein:
the SRB5 is released in response to the first network node receiving an instruction from the second network node to release the SRB5; or
the SRB5 is released on expiry of a predefined time period set for retaining the configurations.

51. The method of claim 41, the method comprising:
handling unsent reports on the QoE measurements for which the configurations configured by the secondary network node are released.

52. The method of claim 51, wherein:
handling the unsent reports comprises any one or both of:
transmitting a second message comprising the unsent reports towards the secondary network node; and
deleting the unsent reports at the UE.

53. The method of claim 41, wherein:
the release of the configurations is triggered in the absence of the primary network node taking over management of the configurations from the secondary network node.

54. The method of claim 41, the method comprising:
receiving, from the primary network node, an indication to transmit remaining reports generated according to the configurations to the primary network node instead of the secondary network node.

55. The method of claim 41, the method comprising:
transmitting, towards the primary network node, an indication about an availability of available reports on the QoE measurements.

56. The method of claim 41, wherein:
the QoE measurements comprise radio access network visible QoE (RVQoE) measurements.

57. A method performed by a first network node of a network for handling quality of experience (QoE) measurements, the method comprising:
establishing connectivity to a user equipment (UE); and
triggering a release, at the UE, of configurations for the QoE measurements, wherein the configurations are configured by the first network node and the release is triggered in response to a termination of the connectivity to the UE.

58. The method of claim 57, the method comprising one or both of:
terminating the connectivity to the UE in response to receiving a request to terminate the connectivity to the UE, wherein the request is received from a second network node of the network for which connectivity is established to the UE; and
providing information to the second network node of the network for which connectivity is established to the UE, wherein the information is about the first network node triggering the release.

59. The method of claim 58, wherein:
the information is provided in response to the first network node determining that the release is to be triggered, or
the information is provided in response to the first network node receiving the request to terminate the connectivity to the UE.

60. The method of claim 58, wherein:
triggering the release comprises triggering the release in response to the second network node granting the first network node permission to trigger the release.

61. The method of claim 54, wherein:
the information is provided prior to triggering the release and comprises an indication that the first network node intends to trigger the release;
the information is provided prior to triggering the release and comprises a request for the second network node to grant the first network node permission to trigger the release; or
the information is provided subsequent to triggering the release and comprises an indication that the first network node has triggered the release.

62. A user equipment (UE), comprising:
processing circuitry configured to cause the UE to:
establish connectivity to a primary network node of a network and a secondary network node of the network; and
trigger a release, at the UE, of configurations for quality of Experience (QoE) measurements, wherein the configurations are configured by the secondary network node and the release is triggered in response to a termination of the connectivity to the secondary network node.

63. A network node, comprising:
processing circuitry configured to cause the network node to:
establish connectivity to a user equipment (UE); and
trigger a release, at the UE, of configurations for Quality of Experience (QoE) measurements, wherein the configurations are configured by the first network node and the release is triggered in response to a termination of the connectivity to the UE.
